(19) United States
(12) Patent Application Publication
(10) Pub. No.: US 2010/0117427 A1
(43) Pub. Date: May 13, 2010

(54) Chair

(76) Inventors: Yoshifumi Fukuyama, Tottori (JP); Tomohisa Shirakawa, Tottori (JP); Hiroshi Nakayama, Hyogo (JP)

Correspondence Address: CLARK & BRODY, 1090 VERMONT AVENUE, NW, SUITE 250, WASHINGTON, DC, 20005, US

(21) Appl. No.: 12/448,848

(22) PCT Filed: Jan. 9, 2008
(86) PCT No.: PCT/JP2008/050105

§ 371 Date: Jul. 10, 2009

(30) Foreign Application Priority Data
Jan. 11, 2007 (JP) 2007-003280
Jul. 24, 2007 (JP) 2007-192433

(51) Int. Cl. A47C 1/00; A47C 3/20; A61H 1/00

(52) U.S. Cl. 297/338; 297/311

(57) ABSTRACT

A chair includes: a seat body (7) an upper surface of which is a seat surface for a user to be seated thereon; a frame (8) supporting the seat body (7) in a manner to permit the seat body (7) to move between a center position and swing positions to which the seat body (7) is swung from the center position; and a driving portion for forcibly moving the seat body (7). The height of the seat surface determined when the seat body (7) is at the center position is lower than the height of the seat surface determined when the seat body is at the swing position.

### TECHNICAL FIELD

The present invention relates to a chair.

### BACKGROUND ARTS

A chair disclosed in Registered Japanese Utility Model Publication No. 3001832 (Document 1), for example, has conventionally been known as a chair adapted to move a seat body. This chair includes: a chair body to be placed on a floor; a seat body horizontally movably supported by the chair body; and a driving portion for driving the seat body. The chair operates as follows. When a motor of the driving portion rotates, the seat body is brought into reciprocative linear motion or circular motion on a horizontal plane.

Further, conventionally known chairs (chair massagers) for massaging shoulder areas, back area and lower-back area of a user include one wherein a backrest portion is provided with a massage unit including massaging elements capable of massage motions such as kneading and tapping.

A chair (chair massager) disclosed in Unexamined Patent Publication No. 2007-20927 (Document 2), for example, includes: a base portion to be placed on the floor; a backrest portion upstanding from the base portion for supporting the user's back; and a seat portion mounted to the base portion for allowing the user to be seated thereon.

As leaning on the backrest portion, the user can get a massage by the massage unit.

### DISCLOSURE OF THE INVENTION

In the chair disclosed in the above document 1, the seat body makes a one-dimensional linear reciprocating motion on a line on a horizontal plane, or a two-dimensional motion of moving on a circle on a horizontal plane. That is, the seat body makes monotonous motions. In the arrangement wherein the seat body is moved thereby giving the user seated thereon feeling of relaxation, the relaxing effect is poor because the seat body makes the planar and monotonous motions.

In view of the foregoing, the invention seeks to provide a chair adapted to bring the seat body into a swing motion including a component in a height direction.

According to the invention, a chair comprises a seat portion for a user to be seated thereon and is characterized in that the seat portion makes a swing motion including a component in a height direction.

The above chair further comprises: a seat body an upper side of which defines a seat surface for a user to be seated thereon and which belongs to the seat portion, and a frame supporting the seat body in a manner to permit the seat body to move between the center position and swing positions to which the seat body is swung from the center position, and is characterized in that a height of the seat surface determined when the seat body is at the center position is lower than a height of the seat surface determined when the seat body is at the swing position.

According to this constitution, the height of the seat surface is varied by moving the seat body between the center position and the swing position. Namely, the seat body is capable of swing motion including a component in the height direction.

It is preferred that the above chair further comprises a driving portion for forcibly moving the seat body. This chair is capable of automatically rocking the user seated on the seat body because the seat body can be moved by the driving portion.

It is preferred that the above chair further comprises: a sensor for detecting the position of the seat body; and a returning operation portion operating based on the position of the seat body detected by the sensor for returning the seat body to the center position as the reference position.

In this constitution, the position of the seat body can be detected by the sensor so that the returning operation portion can operate based on the detected position to return the seat body to the reference position.

It is preferred in the above chair that the frame includes support members for suspendingly supporting the seat body. In this case, the support members are designed to support the seat body as suspending the seat body and to bring the seat body into the swing motion. In the constitution wherein the support members suspendingly support the lateral sides of the seat body, the seat body located at the center position presents the seat surface at the lower height than the level of the seat surface of the seat body located at the swing position.

It is preferred in the above chair that as located at the swing position, the seat surface assumes a horizontal position or a position downwardly inclined toward the center position.

In this constitution, with the seat body located at the swing position, the seat surface is in the horizontal position or downwardly inclined toward the center position. This is effective to prevent the user seated on the seat body moved to this swing position from feeling as if the user were sliding outward from the seat surface in the swing direction. Conversely, if the seat body located at the swing position assumes a position in which the seat surface is downwardly inclined toward the outside in the swing direction, the seat body may make the user feel as if he/she were sliding outward from the seat surface.

Further, the chair can bring the user seated on the seat body into the swing motion about a point higher than the seat surface because the seat body located at the center position presents the seat surface at the lower level whereas the seat body located at the swing position presents the seat surface at the higher level and because the seat surface assumes the horizontal position or the position downwardly inclined toward the center position. Thus is reduced in the swing amount of the head of the user as compared with the case where the seat surface is downwardly inclined toward the outside in the swing direction.

In the conventional chair (chair massager) equipped with a seat portion and a backrest portion (see the above-described document 2), various improvements have been made such as to offer novel body sensation to the user. For example, an air cell inflated or deflated by supplying or discharging air is employed for giving the user a soft massage. Further, a vibrator is incorporated in the seat portion or the backrest portion.

In this connection, the invention seeks to provide a chair (chair massager) capable of offering a novel body sensation to the user.

The chair according to the invention comprises a seat portion for the user to be seated thereon and is characterized in that the seat portion makes a swing motion including a component in the height direction.

The above chair further comprises: a base portion to be placed on a floor; a backrest portion provided at the base portion for supporting the upper body of the user; the seat portion having a seat surface defined by an upper side thereof; a mounting portion transversely movably mounting the seat portion to the base portion in a manner that the seat portion is moved rightward as raising a right end portion of the seat surface higher than a left end portion thereof and that the seat portion is moved leftward as raising the left end portion of the seat surface higher than the right end portion thereof; and a driving portion for driving the seat portion into sideways motion.

According to the invention, the seat portion is moved sideways as raising the left end portion of the seat surface higher or the right end portion thereof higher. Therefore, the seat portion is capable of making the sideways swing motion including the component in the height direction. In the chair including the seat portion and the backrest portion, the seat portion is driven into the sideways swing motion for offering the novel body sensation to the user.

It is preferred that the above chair further comprises armrest portions disposed on lateral sides of the base portion for supporting the arms of the user and is characterized in that the seat portion is transversely moved between the right and left armrest portions.

Because of the armrest portions on the lateral sides, this chair can make the user feel safe and relaxed when the seat portion is moved sideways.

It is preferred that the mounting portion includes arm members which support the seat portion as lifting the lateral sides thereof upward from the lateral sides of the base portion and which are varied in the angles of rightward and leftward inclinations thereby providing for the sideways motion of the seat body.

In this constitution, the arm members support the seat portion as uplifting the same from below. Therefore, the arm members do not abut on the lateral sides of the seat portion so that the seat portion (seat surface) can be increased in the transverse dimension.

It is preferred that the above chair further comprises an operative mechanism portion for switching the state of the seat portion between a stationary state wherein the seat portion is held stationary by preventing the variation of the angles of the rightward and leftward inclinations of the arm members upliftingly supporting the seat portion and an operable state wherein the arm members can be varied in the angles of rightward and leftward inclinations thereby providing for the sideways motion of the seat portion.

In this constitution, the seat portion can be brought into the stationary state or the operable state.

The above chair is characterized in that the mounting portion includes right and left arm members which extend from the lateral sides of the base portion for supporting lateral sides of the seat portion and which are varied in the angles of rightward and leftward inclinations thereby providing for the sideways motion of the seat body, and that the right and left arm members transversely movably mount the seat portion to the base portion in a manner that the right and left arm members are inclined at different angles thereby moving the seat portion rightward as uplifting the right end portion of the seat surface higher than the left end portion or thereby moving the seat portion leftward as uplifting the left end portion of the seat surface higher than the right end portion.

Thus is provided the constitution wherein the seat portion is moved sideways as raising the left end portion of the seat surface higher or the right end portion thereof higher.

It is preferred that the above chair further comprises a sensor for detecting a rightward or leftward position of the seat portion; and a control unit for providing a control to bring the seat portion to a stop at a predetermined rightward or leftward position based on a detection signal from the sensor.

In this constitution, the control unit can bring the seat portion to a stop at the predetermined rightward or leftward position based on the detection signal from the sensor.

### BRIEF DESCRIPTION OF THE DRAWINGS

FIG. 1 is a perspective view showing a chair according to one embodiment of the invention;

FIG. 2 is a perspective view showing a seat structure including a frame, a seat body and support members;

FIG. 3 is a perspective view showing the seat body and the support members;

FIG. 4 is a perspective view of the seat body, the support members and a driving portion as seen from the rear;

FIG. 5 is a perspective view of the driving portion;

FIG. 6 is a group of front views for explaining motions of the seat body;

FIG. 7a is a schematic diagram illustrating the chair of the invention and FIG. 7b is a schematic diagram illustrating a conventional chair;

FIG. 8 is a schematic diagram showing an exemplary modification of the seat structure of the chair of the invention;

FIG. 9 is a schematic diagram showing a chair according to another embodiment of the invention;

FIG. 10a is a sectional view showing a backrest portion of the chair according to another embodiment of the invention and FIG. 10b is a sectional view showing an exemplary modification of the backrest portion;

FIG. 11 is a group of schematic diagrams of the chair of the invention as seen from above, particularly showing the backrest portion in section;

FIG. 12 is a schematic diagram showing a chair according to another embodiment of the invention;

FIG. 13 is a perspective view showing a chair (chair massager) according to one embodiment of the invention;

FIG. 14 is a side view showing a base portion;

FIG. 15 is a perspective view showing a seat structure including a seat frame, a seat portion and a mounting portion;

FIG. 16 is a perspective view of the seat structure as seen from below;

FIG. 17 is a front view showing the seat structure;

FIG. 18 is a front view of the seat structure, showing the seat portion moved leftward;

FIG. 19 is a front view of the seat structure, showing the seat portion moved rightward;

FIG. 20 is a diagram for explaining a movement locus of the seat body; and

FIG. 21 is a diagram illustrating a chair (chair massager) according to another embodiment of the invention.

### BEST MODES FOR CARRYING OUT THE INVENTION

The embodiments of the invention will hereinbelow be described with reference to the accompanying drawings.

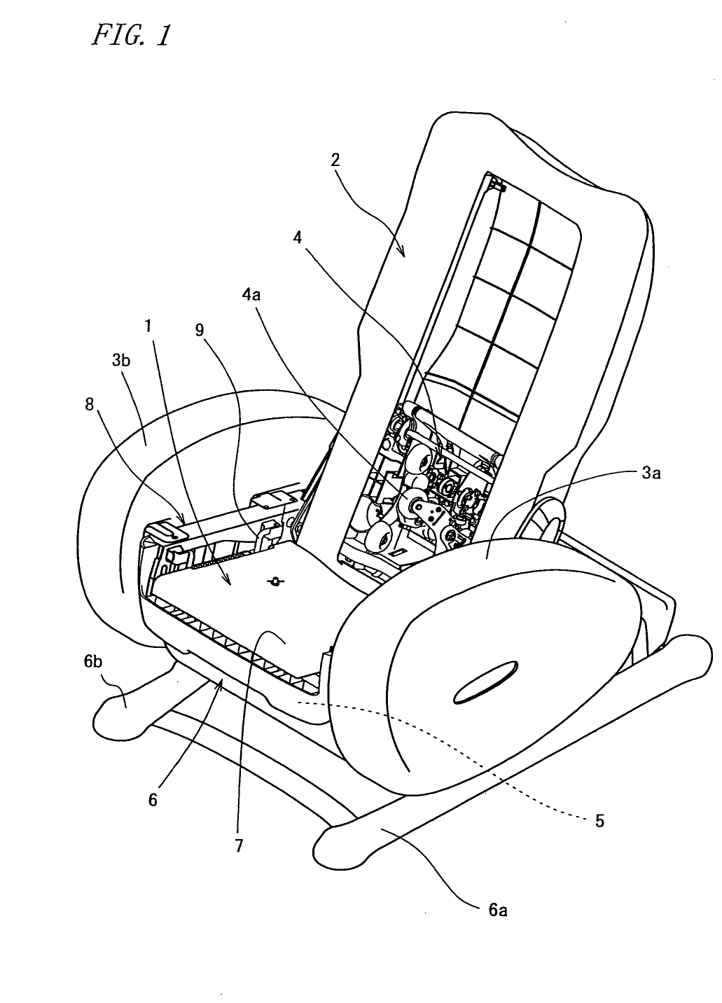

FIG. 1 is a perspective view showing a chair according to one embodiment of the invention. The chair includes: a chair body 6 possessing lateral legs 6a, 6b to be placed on a floor; a seat portion 1 supported on the chair body 6; a backrest portion 2 upstanding from the rear part of the seat portion 1 so as to make contact with the back and the head of a user; and armrest portions 3a, 3b disposed on lateral sides of the seat portion 1 for supporting the elbows and the forearms of the user. The seat portion 1 makes contact with the hips and femoral regions (thighs) of the user (one to be massaged) seated thereon. Although the backrest portion 2 is provided with a covering member and a pad on the front side thereof, these members are not shown in FIG. 1.

The backrest portion 2 is tiltably supported by the chair body 6. A reclining mechanism (not shown) for changing the tilt angle of the backrest portion 2 is provided between the chair body 6 and the backrest portion 2. The reclining mechanism includes, for example, an actuator driven by an electric motor into extending/contracting motion. When the actuator is extended, the backrest portion is brought into an upright position. When the actuator is contracted, the backrest portion is brought into a tilt-back position. Although not shown in the figure, the seat portion 1 may be provided with a leg-rest portion on a front side thereof, which makes contact with the legs of the seated user.

At least one of the seat portion 1, the backrest portion 2 and the leg-rest portion is provided with a massaging device for massaging the user. The massaging device may be exemplified by a massaging unit 4 including a massaging element 4a disposed at the backrest portion 2. Other examples of the massaging device include air cells, vibrators and the like (not shown). A control unit 5 for controlling the operations of an air supplying device for feeding air to the air cells and of the individual massaging devices and for controlling the operations of the seat portion 1 and the backrest portion 2 is disposed at the chair body 6 (under the seat portion 1).

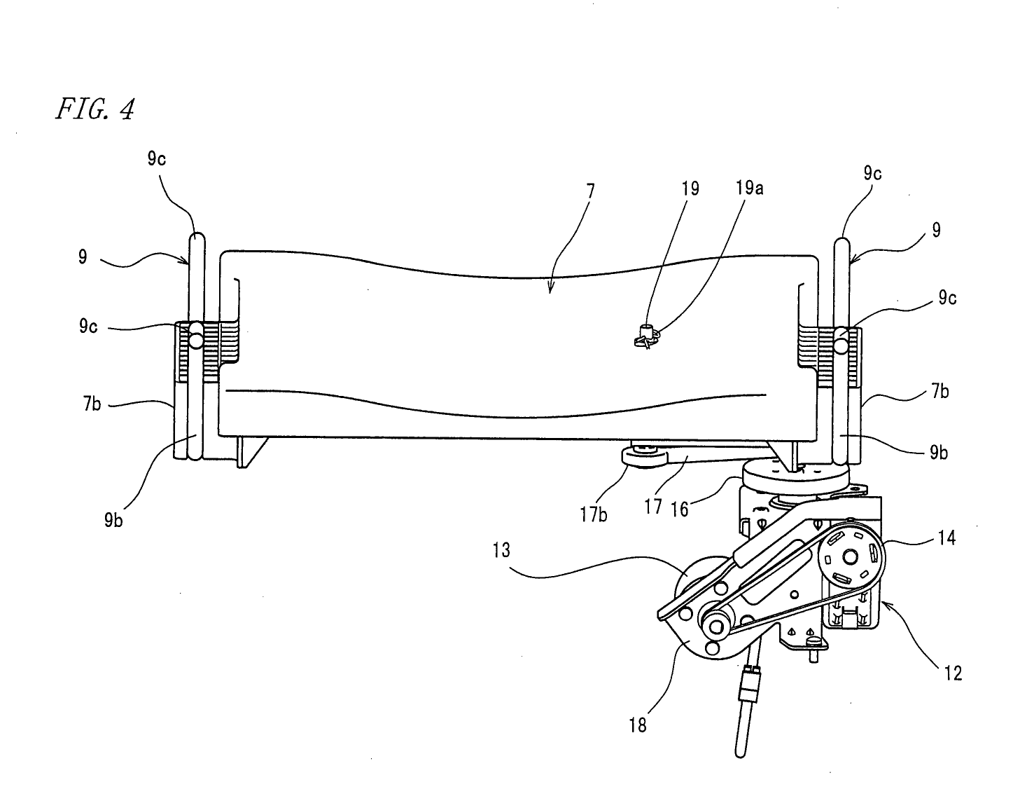

The control unit 5 is connected to a controller (not shown) operated by the user. The controller is operated for turning the power on or off or for performing various massaging motions. The controller is provided with a power button for power on/off control, a stop button, a massage course select button, an operation start button for activating a driving portion 12 to be described hereinlater (see FIG. 4), an operation stop button therefor and the like.

The seat portion 1 includes a seat body 7 an upper side of which defines a seat surface for the user to be seated thereon. The seat body 7 includes a pad at an upper part thereof, which is not shown in FIG. 1. The seat body 7 is a plate-like member formed in a rectangular shape as seen in plan.

The chair body 6 includes a frame 8 supporting the seat body 7. The frame 8 is connected with the legs 6a, 6b so as to be fixed to place on the floor. The frame 8 includes support members 9, by means of which the frame 8 swingably supports the seat body 7. In the illustrated chair, the frame 8 supports the seat body 7 as allowing the seat body to swing sideways. According to the invention, the frame 8 may also support the seat body 7 as allowing the seat body to swing back and forth or to swing on a circular path.

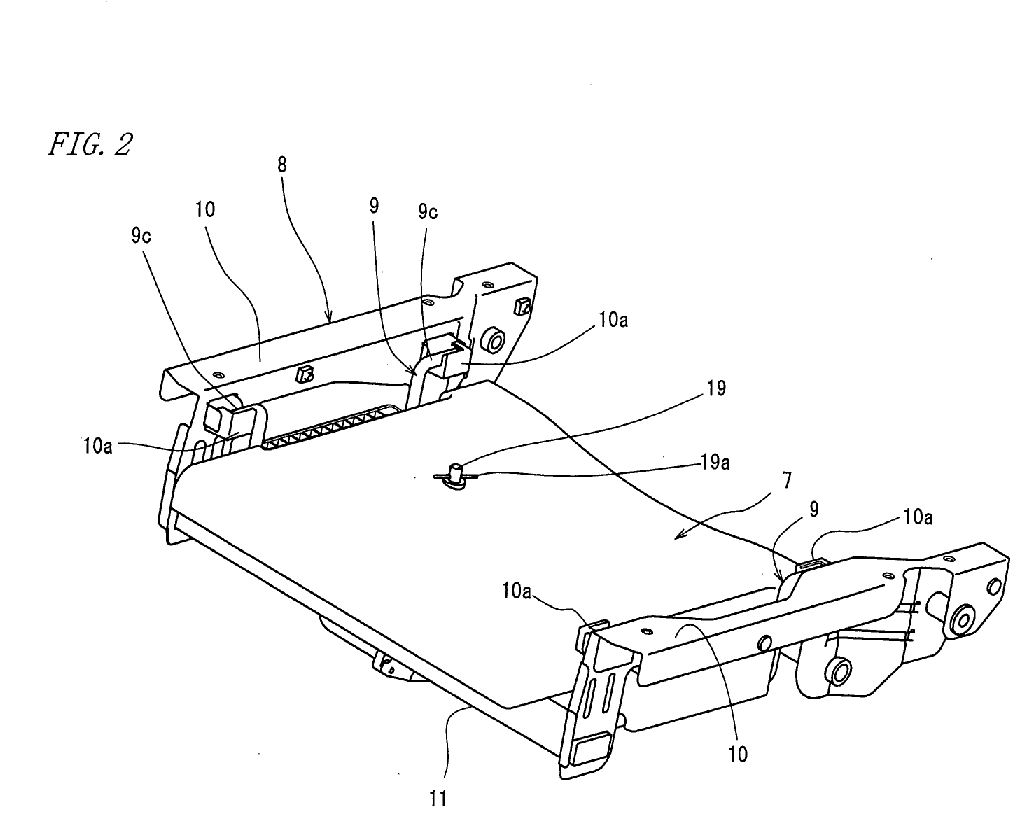

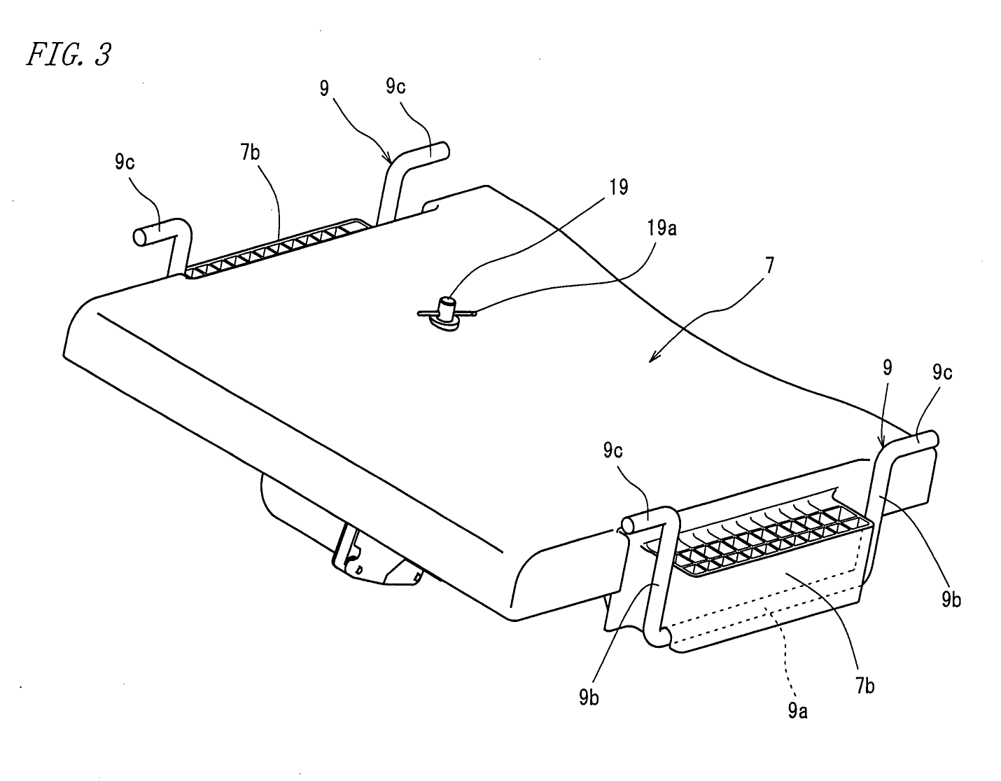

FIG. 2 is a perspective view showing a seat structure including the frame 8, the seat body 7 and the support members 9. FIG. 3 is a perspective view showing the seat body 7 and the support members 9.

In FIG. 2, the frame 8 includes side wall portions 10 on the lateral sides thereof, and a connecting portion 11 interconnecting the side wall portions 10 at lower parts thereof. The support members 9 are disposed on the lateral sides of the frame 8. As shown in FIG. 3, the support member 9 is a member composed of a round bar generally having a U-shape. The support member 9 includes a main body 9a extended in a fore-aft direction, arm portions 9b individually extended upward from front and rear ends of the main body 9a, and upper portions 9c extended from the respective upper ends of the arm portions 9b in the fore-aft direction. The support member 9 may be formed by plastically deforming a metal bar member, for example.

Referring to FIG. 3, the seat body 7 includes mounting portions 7b projecting from the lateral sides thereof in transversely outward directions. The mounting portion 7b is inserted between the front and rear arm portions 9b of the support member 9.

The mounting portion 7b is formed with a groove on a lower side thereof, which is engaged with the main body 9a of the support member 9. The main bodies 9a can support the mounting portions 7b from below. The main bodies 9a and the mounting portions 7b are in pivotable relation to each other. Referring to FIG. 2, the side wall portion 10 of the frame 8 is provided with receiving portions 10a at front and rear places on an inside surface thereof. The receiving portions 10a are engaged with the upper portions 9c of the support member 9. The receiving portions 10a can support the upper portions 9c from below. The receiving portions 10a and the upper portions 9c are in pivotable relation to each other. Thus is provided a structure wherein the frame 8 supports the seat body 7 as allowing the seat body to be suspended on the right and left support members 9. The seat body 7 is capable of swinging sideways like a swing suspended on lateral sides thereof.

The center of the swing motion of the seat body 7 is located above a mounting position of the seat body 7 and the support member 9. Specifically, the center line of the upper portions 9c of the support member 9 which constitutes the center of the swing motion of the seat body 7 is located above the mounting position of the mounting portion 7b of the seat body 7 and the main body 9a of the support member 9.

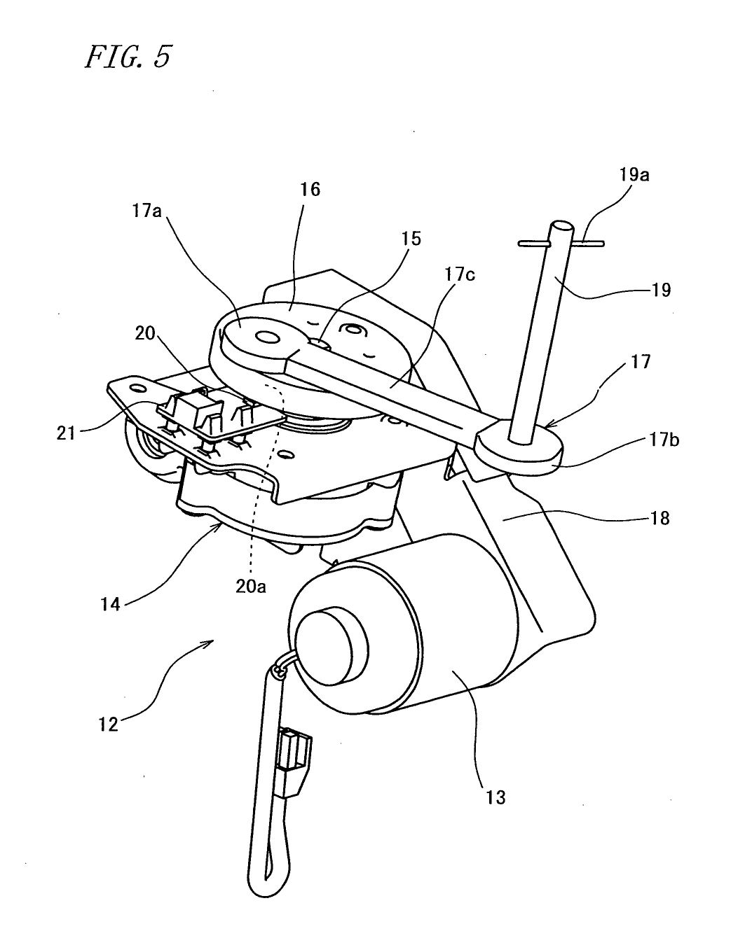

The chair (seat structure) further includes a driving portion 12 (see FIG. 4) for forcibly moving the seat body 7. FIG. 4 is a perspective view of the seat body 7, the support members 9 and the driving portion 12 as seen from the rear (from the backrest-2 side). FIG. 5 is a perspective view of the driving portion 12. The driving portion 12 includes: a motor 13; a speed reducer 14 for reducing the number of revolutions of the motor 13; a rotary member 16 rotated together with an output shaft 15 of the speed reducer 14; and a universal joint 17 having a first end 17a mounted to the rotary member 16 and a second end 17b mounted to the seat body 7.

The motor 13 and the speed reducer 14 are mounted to a frame member 18, which is fixed to the chair body (frame 8) (see FIG. 1). The output shaft 15 has a vertically extended axis, about which the rotary member 16 is driven into rotation. The rotary member 16 is rotatably connected with the first end 17a of the universal joint 17 at a place decentered from the output shaft 15. The universal joint 17 is adapted for 360-degree oscillation between the opposite ends 17a, 17b and a main body 17c thereof, while the first end 17a and the second end 17b are capable of relative displacement in the vertical direction. The universal joint 17 is constructed to include ball joints at the opposite ends 17a, 17b thereof, for example.

The second end 17b of the universal joint 17 is connected to the seat body 7 by means of a pin 19. The pin 19 is inserted through a vertical hole (through hole) extended through the seat body 7 and is prevented from disengaging from the seat body 7 by means of a retaining pin 19a. The pin 19 is free to rotate relative to the seat body 7.

The motor 13 is capable of forward/backward rotations based on signals from the control unit 5. When the motor 13 rotates in one direction, the rotary member is rotated in one direction thereby bringing the universal joint 17 into eccentric rotation. Thus, the universal joint 17 functions as a crank member, driving the seat body 7 supported by the support members 9 into reciprocative swing motion in the transverse direction.

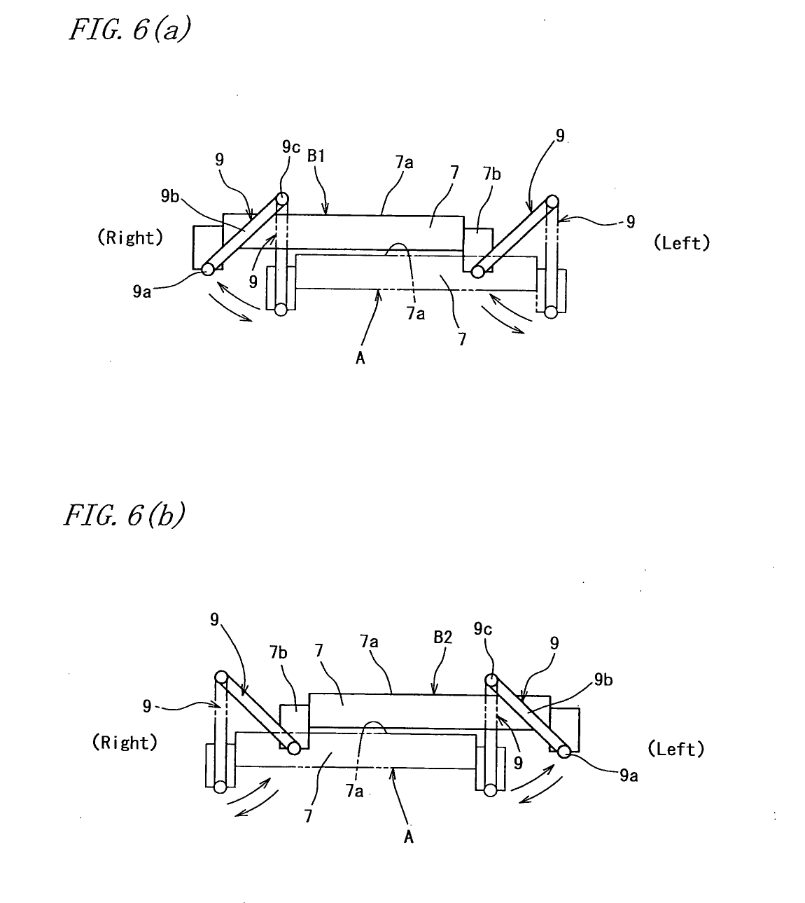

FIG. 6 is a group of front views for explaining the motion of the seat body 7. Now the motion of the seat body 7 is described. It is noted that the frame 8 and the driving portion 12 are not shown in FIG. 6. Referring to FIG. 2 and FIG. 6, the frame 8 supports the seat body 7 in a manner that the seat body 7 is movable between the lateral side wall portions 10 or between a center position A and each of the swing positions B1, B2 shifted sideways from the center position A. Specifically, the frame 8 supports the seat body 7 in a manner to permit the seat body to swing between the transversely opposite swing positions B1, B2 across the center position A.

The driving portion 12 (see FIG. 4) operates thereby forcibly bringing the seat body 7 into the reciprocative swing motion in the transverse direction. FIG. 6a shows the seat body 7 swung from the center position A to the rightward swing position B1 (hereinafter, referred to as “the rightward swing position B1”). FIG. 6b shows the seat body 7 swung from the center position A to the leftward swing position B2 (hereinafter, referred to as “the leftward swing position B2”). The seat body 7 is capable of repeating the swing motion with swing stroke ends defined by the rightward swing position B1 and the leftward swing position B2. The above-described center position A is defined by the center between the right and left swing stroke ends.

Namely, one swing motion of the seat body 7 (swing to one side) to either the rightward swing position B1 (first swing position) or the leftward swing position B2 (second swing position) is equivalent to one stroke. A state where the seat body 7 is at the center position A is defined as the stroke center. A state where the seat body 7 is at the rightward swing position B1 or the leftward swing position B2 is defined as the stroke end.

According to the above embodiment, as shown in FIG. 6, the height at the center of a seat surface 7a, as determined when the seat body 7 is at the center position A, is lower than the height at the center of the seat surface 7a as determined when the seat body 7 is at the rightward swing position B1 (FIG. 6a) and lower than a height at the center of the seat surface 7a as determined when the seat body 7 is at the leftward swing position B2 (FIG. 6b). In other words, the height of the seat surface 7a as determined at the center of seat body 7 located at the stroke center is lower than that of the seat surface 7a as determined at the center of the seat body 7 located at the stroke end. Furthermore, as shown in FIG. 6, the seat surface 7a of the seat body 7 is in a horizontal position when the seat body is located at each of the center position A, the rightward swing position B1 and the leftward swing position B2.

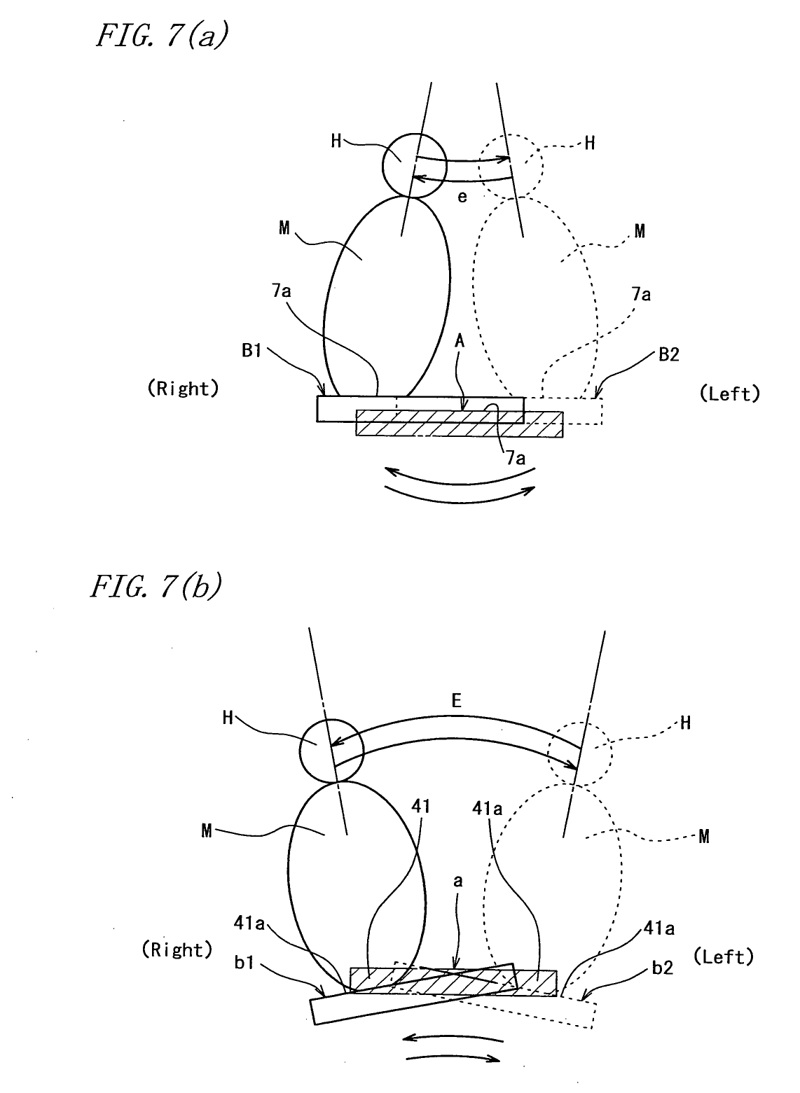

FIG. 7b is a schematic diagram illustrating a conventional chair. The conventional chair shown in FIG. 7b has a seat structure wherein, similarly to that of the invention, a frame (not shown) movably supports a seat body 41, which can be moved to any of a center position a, a rightward swing position b1 shifted rightward from the center position a and a leftward swing position b2 shifted leftward from the center position a. In contrast to the structure of the invention, the height at the center of a seat surface 41a as determined when the seat body 41 is located at the center position a is higher than the height at the center of the seat surface 41a as determined when the seat body 41 is located at the rightward or leftward swing position b1, b2. In the conventional chair, the seat surface 41a is downwardly inclined toward the outside in the transverse direction or the swing direction when the seat body 41 is located at the rightward or leftward swing position b1, b2. Further, the chair brings a user M seated on the seat body 41 into a swing motion about a point lower than the seat surface 41a.

This involves a fear that the chair may make the user M seated on the seat body 41 feel as if the user were sliding outward from the seat surface 41a in the transverse direction when the seat body 41 is swung to the rightward or leftward swing position b1, b2. There is another fear that the user M seated on the seat body 41 swung to the rightward or leftward swing position b1, b2 has his/her head H swung wide in the transverse direction (swing amount E) and hence, the user may have unpleasant feeling such as seasickness.

FIG. 7a is a schematic diagram illustrating the chair of the invention (the above embodiment). According to the invention, as shown in FIG. 7a, the height at the center of the seat surface 7a as determined when the seat body 7 is located at the center position A is lower than the height at the center of the seat surface 7a as determined when the seat body is located at the rightward or leftward swing position B1, B2. Further, the seat surface 7a is in the horizontal position when the seat body is at the rightward or leftward swing position B1, B2. Accordingly, the chair does not make the user M seated on the seat body 7 feel as if he/she were sliding outward from the seat surface 7a in the swing direction when the seat body 7 is swung to the rightward or leftward swing position B1, B2. Thus, the chair can make the user feel safe.

According to the invention, the seat body 7 presents the seat surface 7a at a lower level when located at the center position A, and presents the seat surface 7a at a higher level when located at the rightward or leftward swing position B1, B2, while the seat surface 7a is in the horizontal position. Therefore, the chair is capable of bringing the user M seated on the seat body 7 into a swing motion about a point higher than the seat surface 7a. Thus is reduced the swing amount e of the head H of the user M as compared with the arrangement of the conventional example shown in FIG. 7b (e<E). Further, the user M may swing his/her hips sideways in conjunction with the sideways swing motion of the seat body 7 whereby the swing amount e of the head H may be reduced more effectively.

Referring to FIG. 5, the chair includes a sensor 20 for detecting the position of the seat body 7. The sensor 20 is provided at the driving portion 12 and is designed to detect the position of the seat body 7 by detecting the position of the rotary member 16. Specifically, the sensor 20 is mounted on a base plate 21 fixed to the frame member 18. The rotary member 16 rotates about the axis defined by the output shaft 15. While the rotary member makes one revolution, the seat body 7 makes one reciprocation (two strokes) between the rightward swing position B1 and the leftward swing position B2 (see FIG. 6). That is, the swing position of the seat body 7 and the rotational position of the rotary member 16 are in corresponding relation. Hence, the rotary member 16 is provided with a detection object 20a such that the sensor 20 can detect this detection object 20a whereby the rotational position of the rotary member 16 is determined so as to determine the swing position of the seat body 7.

The sensor 20 may employ a position sensor conventionally known in the art. However, a non-contact sensor, such as a magnetic sensor (Hall IC), may preferably be employed. In this case, what is required is to attach a magnet as the detection object 20a to the rotary member 16.

Thus, the sensor 20 is adapted to detect the seat body 7 located at the center position A by detecting the detection object 20a attached to the rotary member 16 when the seat body 7 is located at the center position A. It is noted that the rotary member 16 may be provided with the detection objects 20a at plural places, while the sensor 20 may be adapted to detect not only the seat body 7 at the center position A but also the seat body 7 at the rightward or leftward swing position B1, B2.

The chair further includes a returning operation portion which operates based on the position of the seat body 7 detected by the sensor 20 so as to return the seat body 7 to the above-described center position A (see FIG. 6) as a reference position. The returning operation portion may comprise the above-described driving portion 12. In this case, the driving portion 12 may be deactivated when the seat body 7 is located at the center position A and the detection object 20a attached to the rotary member 16 is detected by the sensor 20. Specifically, an arrangement may be made, for example, such that the sensor 20 can detect the detection object 20a attached to the rotary member 16 in a state where the seat body 7 is located at the center position A. In a case where the seat body 7 need be brought to a stop at the center position A (reference position) while the driving portion 12 is drivably swinging the seat body 7 based on the signal from the control unit 5 (see FIG. 1) (when the control unit 5 receives a stop signal), the control unit 5 outputs a signal to deactivate the driving portion 12 for locating the detection object 20a at a place to be detected by the sensor 20.

An arrangement to stop the seat body 7 at the center position A may be made such that the operating driving portion 12 is deactivated as soon as the detection object 20a is detected by the sensor 20. However, it is preferred to make an arrangement wherein after the receipt of the stop signal, the control unit 5 permits the driving portion 12 to operate for a while to progressively reduce the swing stroke of the seat body 7 before the driving portion 12 is completely deactivated with the detection object 20a detected by the sensor 20 thereby bringing the seat body 7 to a stop at the center position A.

The control unit 5 can control the driving portion 12 shown in FIG. 5 for bringing the rotary member 16 into forward rotation or backward rotation. This may be accomplished by, for example, switchably driving the motor 13 between the forward rotation and the backward rotation. If the driving portion 12 continues to rotate the rotary member 16 in one direction, the seat body 7 continues the sideways swing motion. In this case, the seat body 7 swings in a reciprocative manner between the rightward swing position B1 and the leftward swing position B2 as the stroke ends (see FIG. 6).

Further, the driving portion 12 can switch the rotary member 16 between the forward rotation and backward rotation based on the signal from the control unit 5, whereby the rotary member 16 can swing the seat body 7 with a smaller stroke as compared with the case where the rotary member 16 drives the seat body 7 into the swing motion by continuously rotating in one direction. Referring to FIG. 6, the rotation of the rotary member 16 is inverted before the seat body 7 moving from the center position A reaches the rightward swing position B1 or the leftward swing position B2 as the stroke end. The rotary member 16 may repeat this operation thereby driving the seat body 7 into a swing motion with smaller strokes.

Further, the control unit 5 can control the driving portion 12 for changing the rotational speed of the rotary member 16. The control unit 5 may provide control, for example, for changing the rotational speed of the motor 13 or the speed reduction ratio of the speed reducer 14. Thus is changed the swing speed of the seat body 7, and the seat body 7 can be brought into a slow swing motion or a quick swing motion.

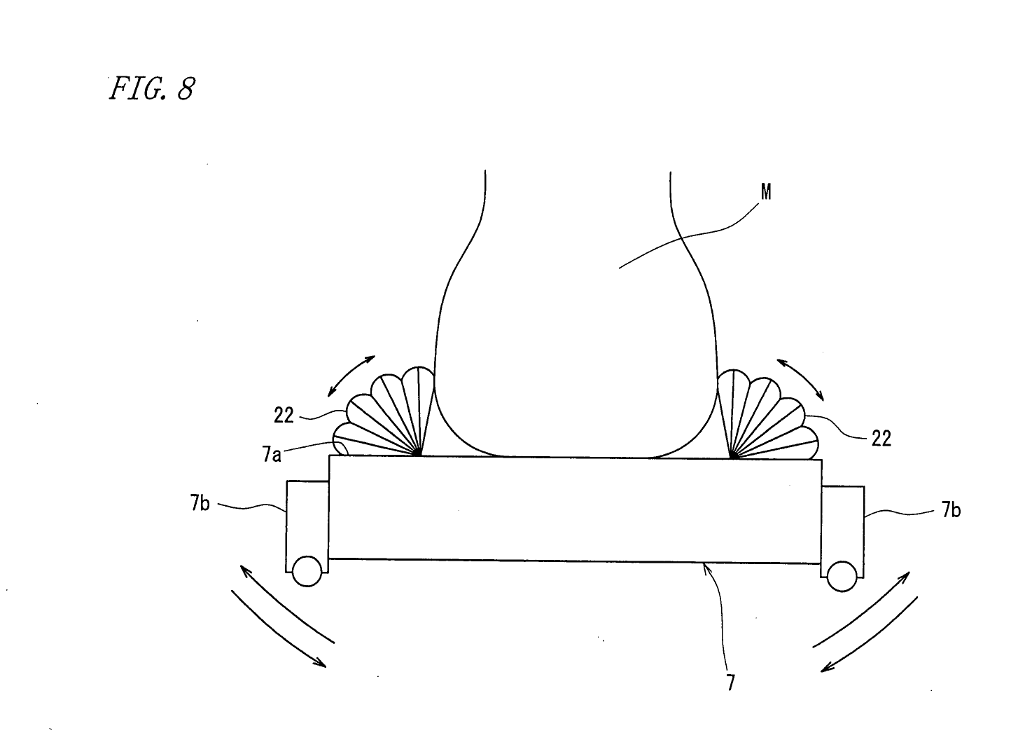

FIG. 8 is a schematic diagram showing an exemplary modification of the seat structure of the chair according to the invention. This seat body 7 includes air cells 22 on the lateral sides thereof, which are inflated or deflated by supplying or discharging air. When inflated, these air cells 22 are capable of holding the user M therebetween as pressing on the lateral sides of the user M seated on the seat body 7. The inflated air cells 22 are capable of pressing on the lateral sides of the user M seated on the seat body 7 in a manner that can hold the hips and femoral regions of the user therebetween. With the air cells 22 holding therebetween the user M seated on the seat body 7, the seat body 7 can be brought into the sideways swing motion as described above. Thus, the user M fixed on the seat body 7 can be brought into the swing motion.

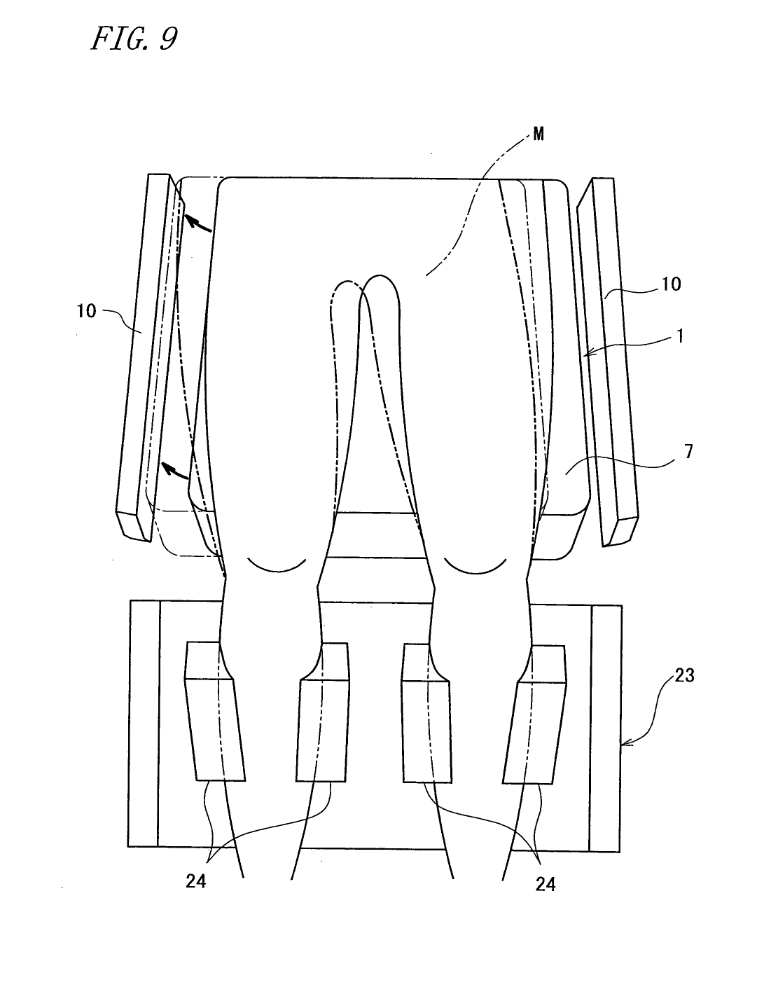

FIG. 9 is a schematic diagram showing a chair according to another embodiment of the invention. This chair is provided with a leg-rest portion 23 on the front side of the seat portion 1 thereof such as to permit the seated user M to rest his/her legs thereon.

The leg-rest portion 23 is provided with claspers 24 for holding the legs of the user M. The claspers 24 may be a massaging device which is adapted to press on respective sural regions of the legs of the user M as holding the respective sural regions on the lateral sides thereof. Particularly, the massaging device may be air cells inflated or deflated by supplying or discharging air. The respective legs can be fixed to the leg-rest portion 23 by inflating the air cells. While the clasper is configured to clasp sural region of a leg, the clasper may be configured to clasp an ankle region of the leg or an ankle and the sural region of the leg.

With the claspers 24 clasping the legs of the user M, the driving portion 12 (see FIG. 4) is capable of brining the seat body 7 into the swing motion. A chain double-dashed line in FIG. 9 depicts the seat body 7 swung to one side in the transverse direction. Thus, the user M seated on the seat body 7 and having the legs fixed to the leg-rest portion 23 is brought into the sideways swing motion. In this manner, the user M may have a region lower than the lower back subjected to an effective swing motion.

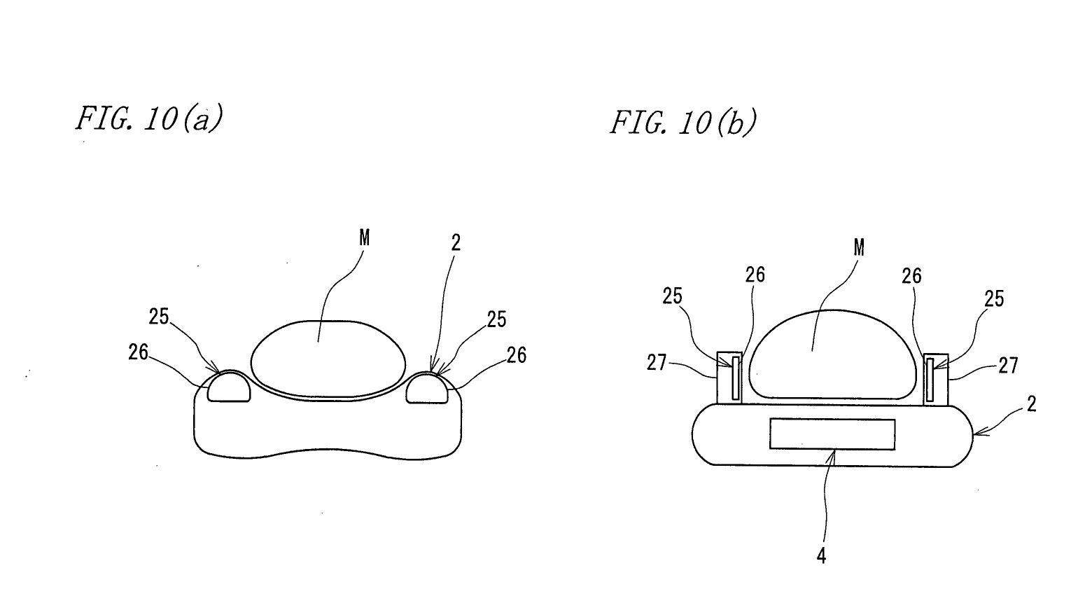

FIG. 10a is a sectional view showing a backrest portion 2 of the chair according to another embodiment of the invention. The backrest portion 2 is provided with massaging devices 25 respectively corresponding to the lateral sides of the back of the user M. The massaging device 25 includes an air cell 26 inflated or deflated by supplying or discharging air. The air cell extends in the height direction of the backrest portion 2. The pair of massaging devices 25 are disposed in a transversely spaced relation and are capable of pressing on the back of the user M in a manner that can hold therebetween the user's back on the lateral sides. In addition, the paired massaging devices 25 hold therebetween the user M on the lateral sides whereby the upper body of the user M is fixed in place and prevented from moving sideways.

FIG. 10b is a sectional view showing an exemplary modification of the backrest portion 2. The backrest portion 2 includes projections 27 projecting forwardly (toward the user-M side) from lateral sides thereof, such that the upper body of the user M is fitted in space between the projections 27. The massaging devices 25 are provided in the inside surfaces of the respective projections 27. The massaging device 25 includes an air cell 26, which is inflated or deflated by supplying or discharging air. The pair of projections 27 (massaging devices 25) are disposed in a transversely spaced relation and are capable of pressing on the back of the user M in a manner that can hold therebetween the user's back on the lateral sides. In addition, the paired massaging devices 25 hold therebetween the user M on the lateral sides whereby the upper body of the user M is fixed in place and prevented from moving sideways.

According to the embodiments shown in FIG. 10a and FIG. 10b, the seat body 7, on which the user M has the upper body fixed in place by means of the pair of massaging devices 25, can be brought into the sideways swing motion by means of the driving portion 12 (see FIG. 4) as described above. In this manner, the seat body 7 with the user M having the upper body fixed to the backrest portion 2 is brought into the motion thereby permitting the user M to have the lower back region subjected to the effective swing motion.

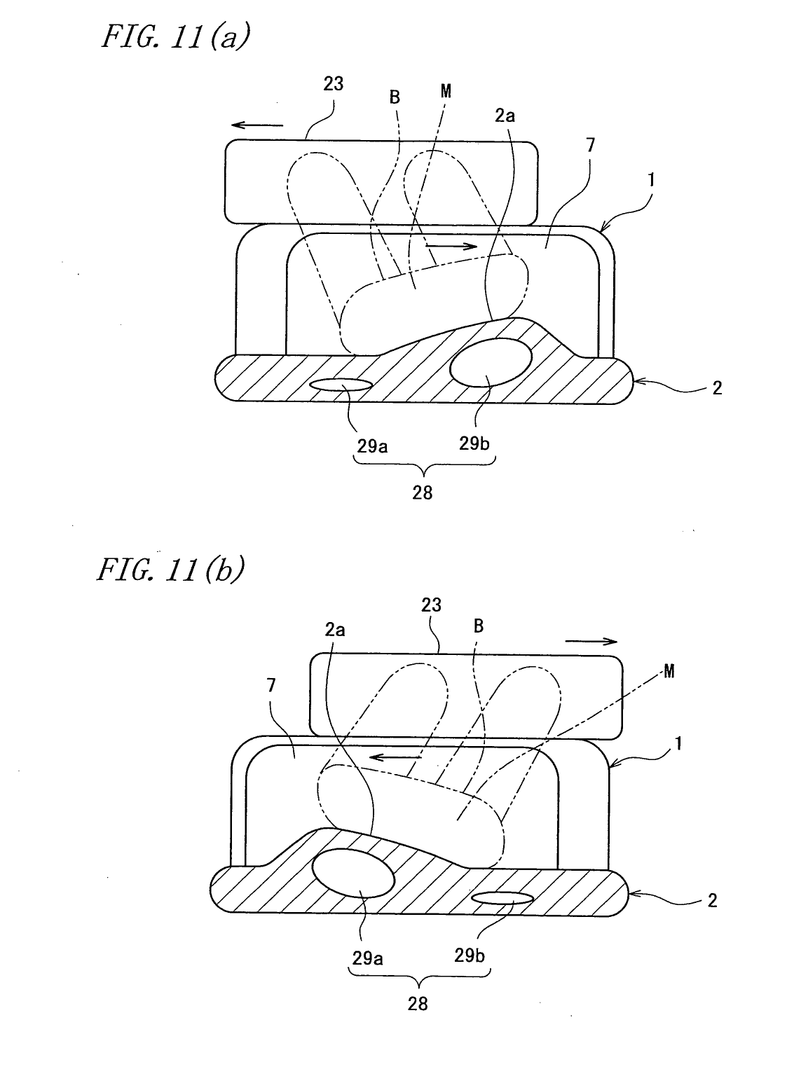

FIG. 11 is a group of schematic diagrams of the chair of the invention as seen from above, showing the backrest portion 2 in section. The backrest portion 2 is provided with operating means 28 for selectively projecting a left side portion or a right side portion of a backrest surface 2a in a forward direction. The operating means 28 shown in FIG. 11 includes massaging devices respectively corresponding to a left side area and a right side area of the back of the user M. The massaging devices are disposed corresponding to the left and the right side areas of the back of the torso of the user M and are capable of alternately pressing forward on the left side area and the right side area of the user's back. The massaging devices include a left-side air cell 29a and a right-side air cell 29b. These air cells 29a, 29b are inflated or deflated by supplying or discharging air.

As shown in FIG. 11a, the control unit 5 provides control to inflate the right-side air cell 29b whereby the right side portion of the backrest surface 2a is projected toward the user (forward) for pressing on the right side area of the user's back. Thus, the user M leaning on the backrest portion 2 is subjected to a twisting motion wherein the right half portion of the upper body (torso) B of the user is projected forwardly of the left half portion of the upper body. On the other hand, as shown in FIG. 11b, the left-side air cell 29a is inflated whereby the left side portion of the backrest surface 2a is projected toward the user (forward) for pressing on the left side area of the user's back. Thus, the user leaning on the backrest portion 2 is subjected to the twisting motion wherein the left half portion of the upper body (torso) B of the user is projected forwardly of the right half portion of the upper body.

The control unit 5 provides control such that while the driving portion 12 brings the seat body 7 into the sideways swing motion, the massaging devices (air cells 29a, 29b) at the backrest portion 2 operate to project the left side portion or the right side portion of the backrest surface 2a in the forward direction. Specifically, when the seat body 7 is swung rightward by the driving portion 12, the right-side air cell 29b is inflated to project forward the right side portion of the backrest surface 2a, as shown in FIG. 11a. As shown in FIG. 11b, on the other hand, when the seat body 7 is swung leftward by the driving portion 12, the left-side air cell 29a is inflated to project forward the left side portion of the backrest surface 2a. This permits the user M to have the upper body subjected to a twisting motion in conjunction with the sideways swing motion of the lower back region.

Further, the control unit 5 alternately effects the operation to move the seat body 7 rightward and to project forward the right side portion of the backrest surface 2a (FIG. 11a) and the operation to move the seat body 7 leftward and to project forward the left side portion of the backrest surface 2a (FIG. 11b). Thus is provided a more effective swing motion for further enhancing the massaging effect.

In the chair shown in FIG. 11, the leg-rest portion 23 is adapted to move back and forth in a longitudinal direction of the retained legs and in a transverse direction orthogonal to the longitudinal direction. The leg-rest portion 23 is drivably moved back and forth in the longitudinal direction and in the transverse direction by a driving means (not shown) for the leg-rest portion 23. Specific examples of the motion made by the leg-rest portion 23 include the sideways swing motion, a back and forth swing motion and a complex swing motion (motion in the shape of an infinity sign) as a combination of the sideways swing motion and the back and forth swing motion. The leg-rest portion 23 is adapted to perform each of these swing motions in any of the following positions: a vertical position in which the leg-rest portion is lowered, a horizontal position in which the leg-rest portion is raised up, and an intermediate position between the vertical position and the horizontal position. Thus, the leg-rest portion 23 can be brought into a two dimensional swing motion in upward and downward directions or in forward and backward directions, or into a three dimensional motion in the upward and downward directions, the forward and backward directions and rightward and leftward directions. FIG. 11a and FIG. 11b show the leg-rest portion 23 swung in the rightward and leftward directions.

The control unit 5 is capable of effecting a complex motion combining any two of or the all of the motions of the leg-rest portion 23, the seat body 7 and the backrest portion 2. Specifically, the control unit 5 is capable of effecting at least two of the following operations in combination: the operation of the driving portion 12 (see FIG. 4) for moving (swinging) the seat body 7 sideways or the like, the operation of the massaging device 28 of the backrest portion 2 for projecting forward the left side portion or the right side portion of the backrest surface 2a, and the operation of the driving means (not shown) of the leg-rest portion 23 for moving the leg-rest portion 23 in a forward and backward direction or a rightward and leftward direction.

While effecting the swing motion of the leg-rest portion 23, for example, the control unit 5 can effect the both or either one of the operation of moving the seat body 7 sideways and the operation of the massaging device 28 of the backrest portion 2 for projecting forward the left side portion or the right side portion of the backrest surface 2a.

Specifically, when operating the driving portion (see FIG. 4) to swing the seat body 7 rightward, the control unit 5 effects the operation of inflating the right-side air cell 29b for projecting forward the right side portion of the backrest surface 2a and the operation of swinging leftward the leg-rest portion 23, as shown in FIG. 11a. In FIG. 11b, when operating the driving portion 12 to swing the seat body 7 leftward, the control unit 5 effects the operation of inflating the left-side air cell 29a for projecting forward the left side portion of the backrest surface 2a and the operation of swinging rightward the leg-rest portion 23. Thus, the motion to swing the lower back region of the user rightward or leftward is accompanied by the motion to twist the upper body and the lower body of the user.

A storage of the control unit 5 of the chair of the invention stores therein a plurality of massage programs. The massage program comprises a plurality of massaging steps. The individual massaging steps are defined to cause the massaging device provided in the chair (such as the massaging element 4a mounted in the backrest portion 2 shown in FIG. 1) to perform a predetermined massaging operation, to bring the seat body 7 into the swing motion, and the like.

One massaging step is programmed such that the massaging operation by the massaging device (massaging element 4a) mounted in the backrest portion 2 is not performed simultaneously with the reciprocative swing motion of the seat body 7. This is to prevent the massaging element 4a from pressing against the backbone of the user in conjunction with the seat body 7 moving sideways in a reciprocative manner.

However, a massaging program may include a massaging step wherein the massaging device mounted in the backrest portion 2 performs the massaging operation in a state where the seat body 7 is moved to and retained at either of the rightward and leftward swing positions. This permits the massaging device in the backrest portion 2 to massage a larger body area of the user. Although the massaging device of the backrest portion cannot be applied to some area of the user M when the seat body 7 is located at the center position A (see FIG. 7), the massaging device can be applied to such area of the user M by bringing the seat body 7 to a stop at either of the rightward and leftward swing positions.

According to the above chair of the invention, the height at the center of the seat surface 7a, as determined when the seat body 7 is at the center position A, is lower than the height at the center of the seat surface 7a as determined when the seat body 7 is at the rightward or leftward swing position B1, B2, as shown in FIG. 7. Therefore, the height of the seat surface 7a is varied in conjunction with the seat body 7 moved between the center position A and the swing position B1, B2. Namely, the seat body 7 is capable of the swing motion including a component in the height direction, giving a comfortable feeling of relaxation to the user M seated on this seat body 7.

The driving portion 12 shown in FIG. 5 is capable of swinging the seat body 7 sideways in a reciprocative manner so that the user seated on the seat body 7 can be brought into the sideways swing motion. In addition, the driving portion 12 is capable of providing a periodical swing motion of the seat body 7. Because of the regular swing motion, the chair can achieve a high relaxation effect.

The chair of the invention is not limited to the illustrated modes but may also be practiced in any other modes which do not depart from the scope of the invention.

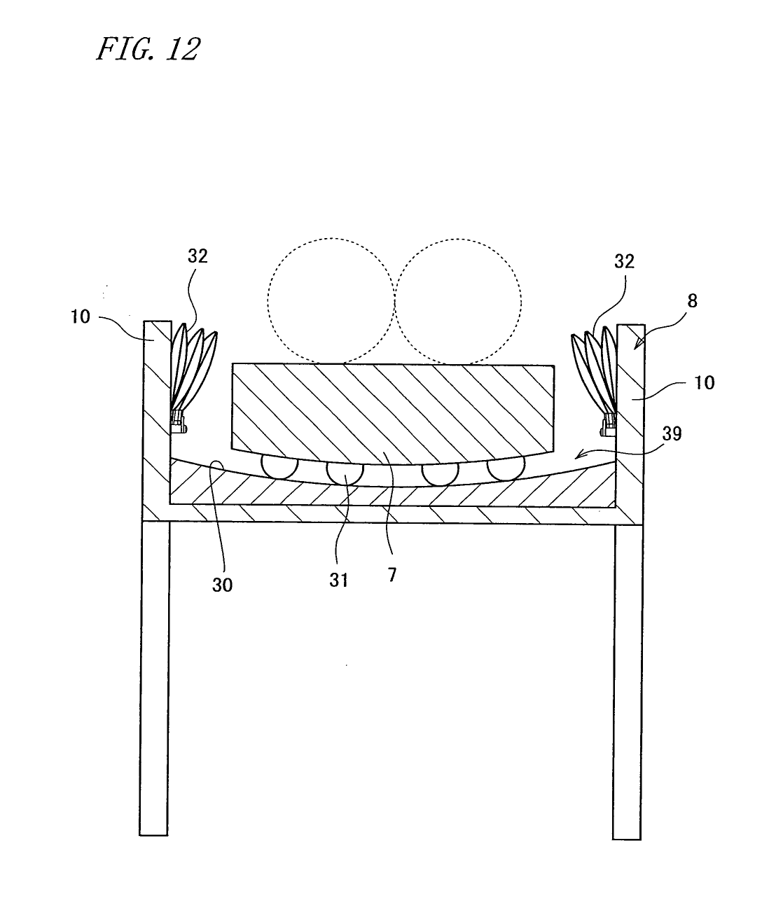

For instance, FIG. 12 is a schematic diagram showing a chair according to another embodiment of the invention. As shown in the figure, a support member 39 of a frame 8 supports the seat body 7 from below. The support member 39 bridges between the lateral side wall portions 10. An upper side of the support member 39 constitutes a recessed support surface 30. The support surface 30 defines a smooth arcuate configuration, a transversely central portion of which is lower than the lateral sides thereof. Rolling members 31 are interposed between the seat body 7 and the support surface 30. This provides for the sideways swing motion of the seat body 7. An air cell 32 as a driving portion is disposed on each of the inside surfaces of the lateral side wall portions 10. The lateral air cells 32 are inflated or deflated by supplying or discharging air. The lateral air cells 32 are alternately inflated for pushing the seat body 7 in turn so that the seat body 7 is alternately swung rightward and leftward.

While the foregoing embodiments illustrate the case wherein the seat body 7 is swung in the transverse direction, the swing direction is not limited to the transverse direction. That is, the swing motion may be made in the transverse direction, the fore-aft direction or in a direction including at least one of the transverse component and fore-aft component. Otherwise, the swing motion may be a motion made along a circular path including such a component. In this case, the above-described support members 9 (see FIG. 3) may employ a flexible member (such as wire) in place of the metal bar member.

FIG. 7a illustrates the chair of the invention wherein the seat surface 7a is in the horizontal position when the seat body 7 is at the rightward swing position B1 or the leftward swing position B2. However, an alternative arrangement (not shown) may be made such that the seat surface 7a is downwardly inclined toward the center position A when the seat body 7 is at the rightward or leftward swing position B1, B2.

In the foregoing embodiments, the driving portion 12 includes the motor 13 as shown in FIG. 5, but is not limited to this constitution. As shown in FIG. 12, the driving portion may be constituted by the air cells 32 inflated or deflated by supplying or discharging air.

The chair constituted as described above can offer a feeling of relaxation to the user because the height of the seat surface is varied in conjunction with the seat body moved between the center position and the swing positions.

A chair (chair massager) according to the invention is described with reference to the drawings.

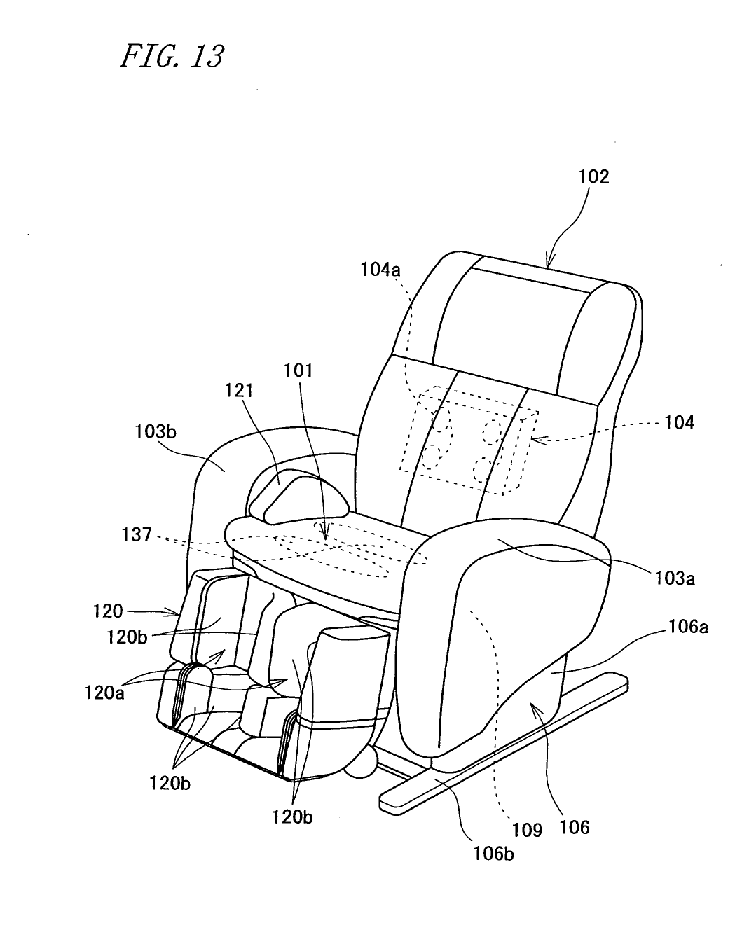

FIG. 13 is a perspective view showing a chair (chair massager) according to one embodiment of the invention. The chair massager includes: a base portion 106 to be placed on the floor; a backrest portion 102 disposed at a rear part of the base portion 106 for supporting the upper body of the user; a leg-rest portion 120 disposed at a front part of the base portion 106 for supporting the legs of the user; a seat portion 101 disposed at the center of the base portion 106 in a fore-aft direction thereof; and armrest portions 103a, 103b disposed on lateral sides of the base portion 106 for supporting the arms of the user.

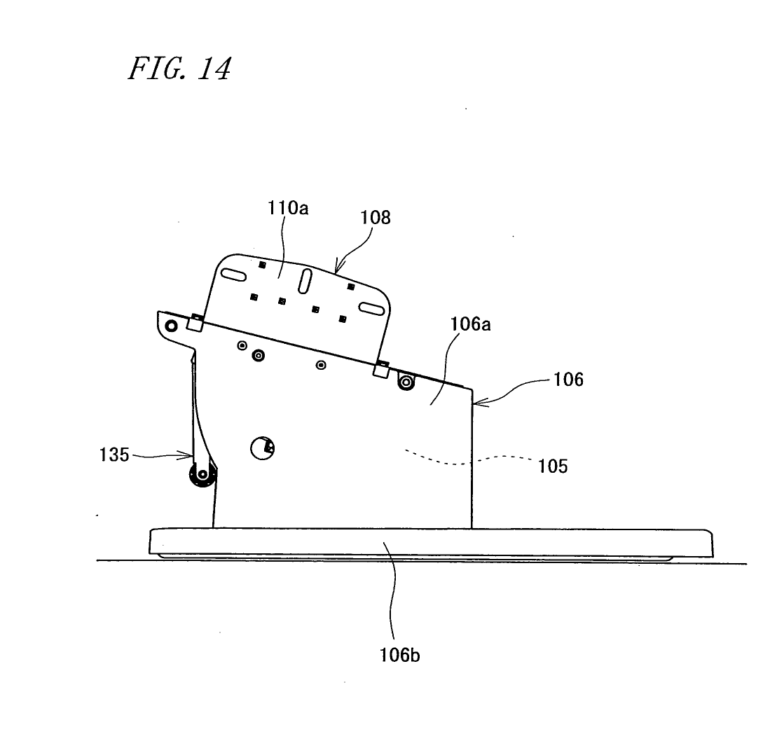

FIG. 14 is a side view showing the base portion 106. The base portion 106 includes a main frame 106a, and a leg portion 106b disposed under the lateral sides of the main frame 106a.

Referring to FIG. 13 and FIG. 14, the backrest portion 102 is tiltable and mounted to a rear part of the main frame 106a. A reclining mechanism (not shown) for changing the tilt angle of the backrest portion 102 is disposed between the main frame 106a and the backrest portion 102. The reclining mechanism includes an actuator driven by, for example, an electric motor into extending/contracting motion. When the actuator is extended, the backrest portion 102 is brought into an upright position. When the actuator is contracted, the backrest portion 102 is brought into a tilt-back position.

Referring to FIG. 13, the backrest portion 102 is provided with a massage unit 104. The massage unit 104 includes a plurality of massaging elements 104a, and a massager driver (not shown) for causing the massaging elements 104a to perform massaging motions such as kneading and tapping. The massage unit 104 is capable of moving upward or downward so as to permit the massaging elements 104a to perform the massaging motions on the shoulders, the back and the lower back region of the user.

The leg-rest portion 120 has its base swingably mounted to the front part of the main frame 106a. This permits a distal end of the leg-rest portion 120 to be moved up and down. A swing motion driving mechanism 135 (see FIG. 14) for swinging the leg-rest portion 120 is disposed between the main frame 106a and the leg-rest portion 120. The swing motion driving mechanism 135 includes, for example, an actuator operated by an electric motor.

Referring to FIG. 13, the leg-rest portion 120 includes a recess 120a for holding the legs of the user. The recess 120a is provided with a massaging device 120b for performing a massaging motion on the user's legs held by the recess 120a. The massaging device 120b may be air cells inflated or deflated by supplying or discharging air.

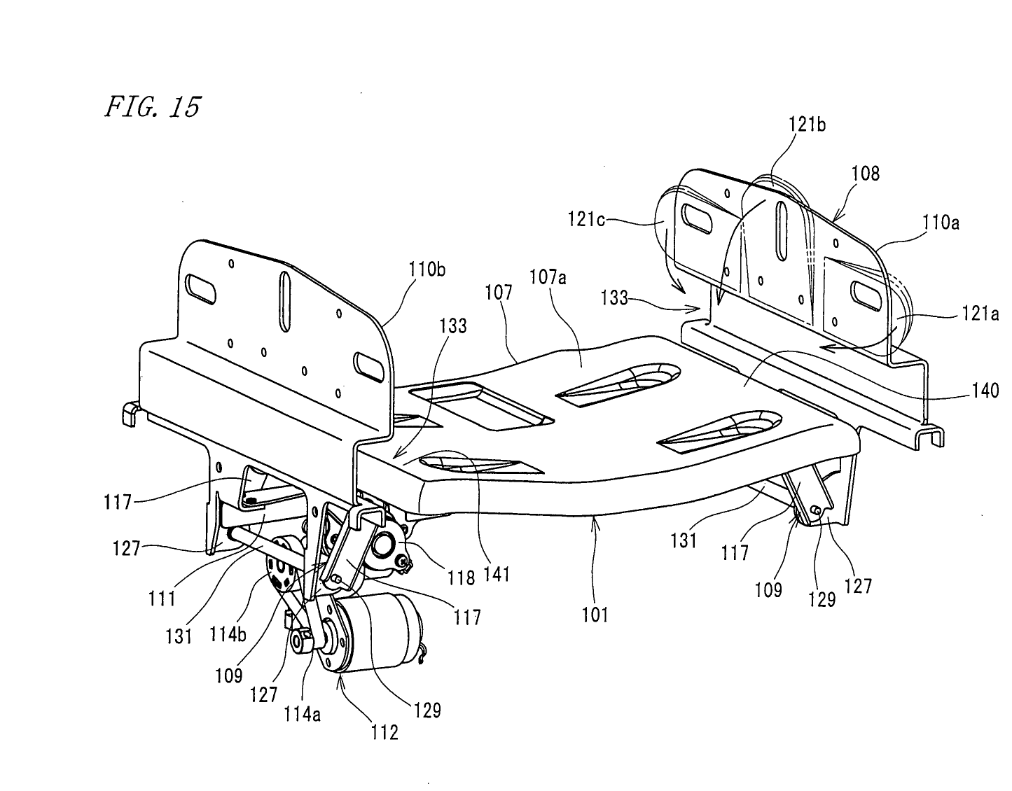

Referring to FIG. 14, the main frame 106a of the base portion 106 includes a seat frame 108 to which the seat portion 101 is mounted. The seat frame 108 is fixed to the main frame 106a. FIG. 15 is a perspective view showing a seat structure including the seat frame 108, the seat portion 101 and a mounting portion 109. The mounting portion 109 fixes the seat portion 101 to the seat frame 108, as will be described hereinlater. The seat structure is designed such that the seat portion 101 can be moved sideways by means of the mounting portion 109.

Referring to FIG. 13, massaging devices 121 are disposed at places on the seat portion 101 and on respective inner sides of the right and left armrest portions 103a, 103b. The massaging devices 121 are air cells inflated or deflated by supplying or discharging air. The massaging devices 121 are mounted to places transversely inwardly of the side wall portions on the lateral sides of the base portion 106. The massaging devices 121 are mounted to respective inner sides of the right and left armrest portions 103a, 103b and hence, are not moved sideways together with the seat portion 101 when the seat portion 101 is moved sideways.

The chair massager includes an air supplying device (not shown) for feeding air to the individual air cells described above, and a control unit 105 for controlling the operations of the operating portions. The air supplying device and the control unit 105 are disposed in the main frame 106a (under the seat portion 101). The control unit 105 controls the operations of the air supplying device, the massage unit 104, the seat portion 101, the backrest portion 102 and the leg-rest portion 120.

The control unit 105 is connected to a controller (not shown) manipulated by the user. The controller is operated for turning the power on or off, or for performing various massaging motions. The controller is provided with a power button for power on/off operation, a stop button, a massage course select button, an operation start button for activating a driving portion 112 (see FIG. 15) which drives the seat portion 101 into the sideways motion as will be described hereinlater, an operation stop button and the like.

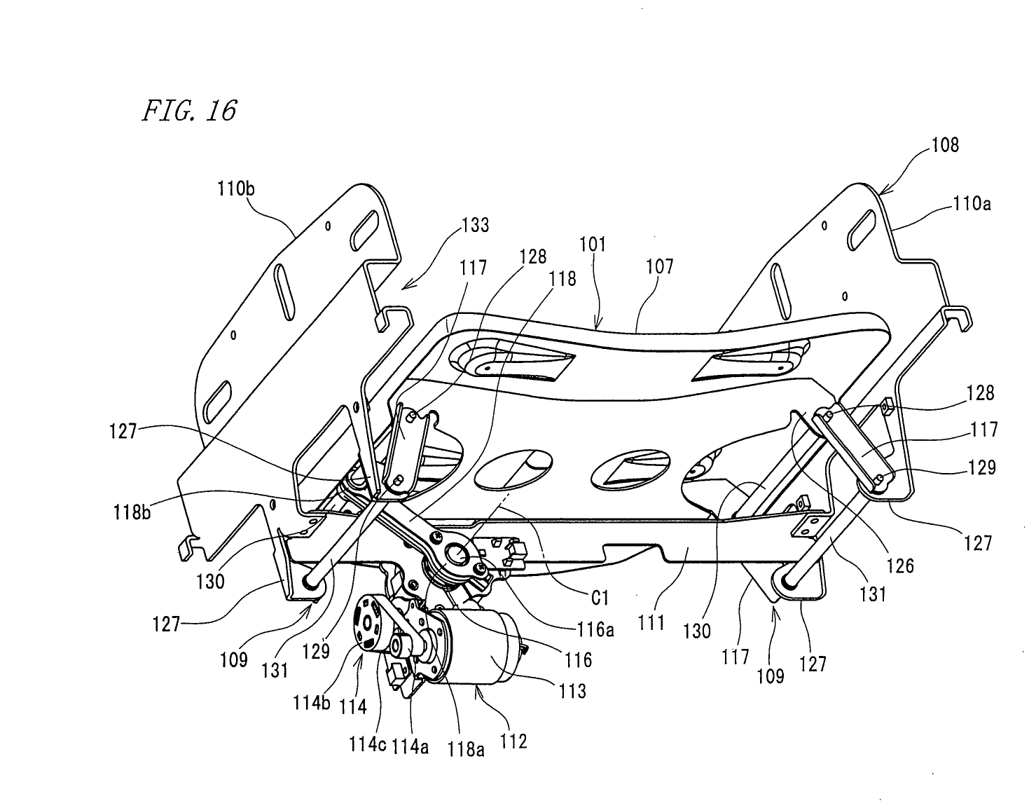

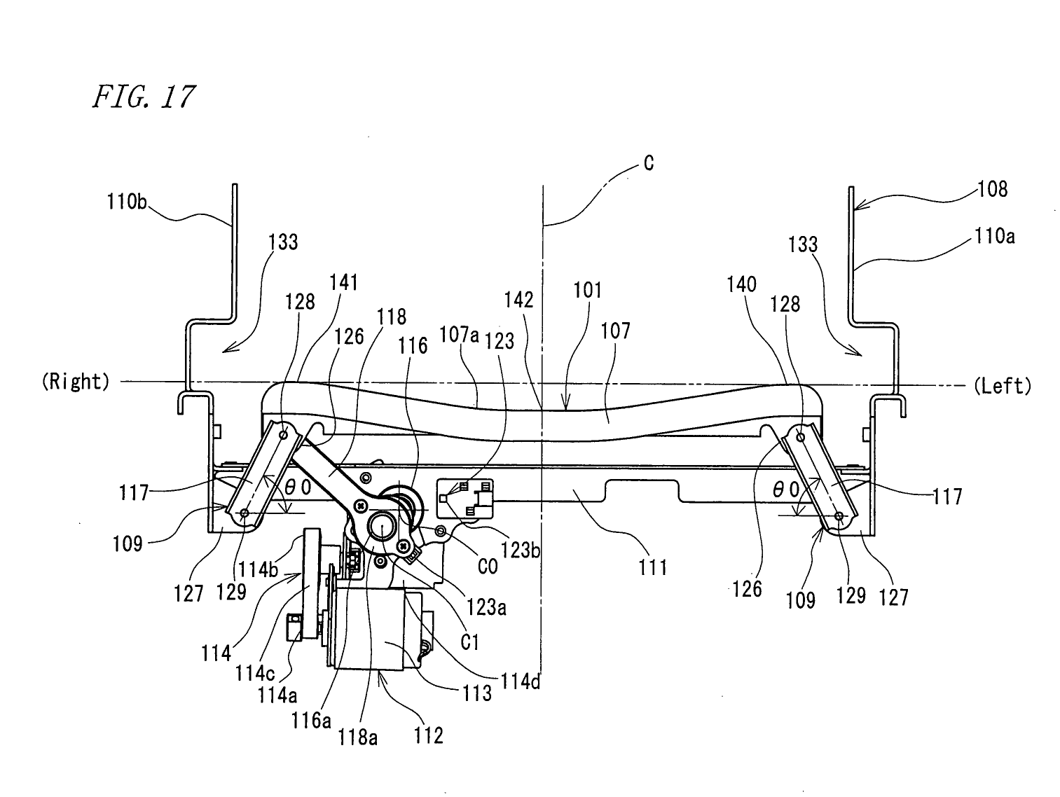

FIG. 16 is a perspective view of the seat structure as seen from below. FIG. 17 is a front view showing this seat structure. Referring to FIG. 15, FIG. 16 and FIG. 17, the seat frame 108 includes side wall portions 110a, 110b on the lateral sides thereof, and an underpart member 111 interconnecting these side wall portions 110a, 110b at lower parts thereof. Each of the side wall portions 110a, 110b includes frame connecting portions 127 extended downward from forward and rearward places thereof. The side wall portions 110a, 110b respectively constitute a part of the inner lateral side of the armrest portions 103a, 103b (see FIG. 13).

The seat portion 101 includes a seat body 107 defining a seat surface 107a on an upper side thereof. While the chair massager is used with a pad placed on the seat body 107, FIG. 15 to FIG. 17 do not illustrate the pad. A seating surface on which the user is actually seated is defined by an upper side of the pad. The seat body 107 is a plate-like member which has a rectangular shape in plan and is formed from metal or resin. Since the seat portion 101 is moved sideways, the seat body 107 defines a concave curve wherein lateral sides thereof (left end portion 140 and right end portion 141) are raised as compared with a central portion 142 thereof in order to assistively support the user seated on the seat surface 107a at the lateral sides of his/her hips and femoral regions (see FIG. 17). The seat body 107 includes seat connecting portions 126 at forward-left, rearward-left, forward-right and rearward-right places on the lower side thereof.

The seat body 107 is transversely movably mounted to the seat frame 108 by means of the mounting portion 109. The mounting portion 109 includes a total of four arm members 117, which extend between the seat frame 108 and the seat body 107 and are fixed to the respective forward-left, rearward-left, forward-right and rearward-right places of the seat frame and the seat body. The arm member 117 is a linear support member which is a plate member formed into a U-shape in section for increased rigidity although the plate member is light in weight.

Each of the arm members 117 has its upper part pivotally connected to the seat connecting portion 126 by means of a first shaft 128 (upper shaft) and has its lower part pivotally connected to the frame connecting portions 127 by means of a second shaft 129 (lower shaft). In FIG. 16, the first front and rear shafts 128 are formed at the opposite ends of an upper connecting shaft 130 extended in the fore-aft direction, so as to be located in the same straight line. The second front and rear shafts 129 are formed at the opposite ends of a lower connecting shaft 131 extended in the fore-aft direction, so as to be located in the same straight line.

Namely, the upper parts of the arm members 117 are connected to the opposite ends (the first shafts 128) of each of the upper connecting shafts 130 disposed on the lateral sides of the seat body 107 and extended in the fore-aft direction thereof. The lower parts of the arm members 117 are connected to the opposite ends (the second shafts 129) of each of the lower connecting shafts 131 disposed on lateral sides of the seat frame 108 and extended in the fore-aft direction thereof. Thus, the seat body 107 is supported by the four arm members 117 disposed the forward-left, rearward-left, forward-right and rearward-right places.

Referring to FIG. 17, the right and left arm members 117 are angularly disposed so as to be progressively decreased in space therebetween toward the top (at an inclination angle of θ0 to the horizontal). In short, the right and left arm members 117 are arranged in an open chevron configuration as seen in the fore-aft direction. The four arm members 117 support the seat body 107 (from below) as uplifting the lateral sides (the seat connecting portions 126) of the seat body 107 from the lateral sides (the frame connecting portions 27) of the seat frame 108. The mounting portion 109 constitutes a link structure wherein the right and left arm members 117 are pivotable about the right and left first shafts 128 and second shafts 129 as the pivot points which are located at the apexes of a trapezoidal shape.

The respective arm members 117 are varied in the angle θ0 of their rightward or leftward inclination thereby permitting the seat body 107 to be moved sideways. Specifically, the arm members 117 are pivotally moved about the second shafts 129 thereby moving the seat body 107 sideways.

An arrangement is made such that the inclination angle to the horizontal of the arm members 117 swung sideways (θ0 and θ1 to θ4 to be described hereinlater) is less than 90°. That is, the arm members 117 are designed to be inclined transversely inwardly as pivoted about the second shafts 129 in conjunction with the sideways movement of the seat body 107. The arm members 117 are designed not to be inclined transversely outwardly.

The chair massager includes the driving portion 112 for forcibly moving the seat body 107 sideways. Referring to FIG. 16 and FIG. 17, the driving portion 112 includes: a motor 113; a speed reducer 114 for reducing the number of revolutions of the motor 113; a rotary member 116 rotated in synchronization with an output shaft (not shown) of the speed reducer 114; and a rod-like power transmission member 118 interposed between the rotary member 116 and the seat body 107. In FIG. 17, the rotary member 116 includes an eccentric shaft portion 116a having an axis C1 eccentrically located relative to the axis C0 (the axis of the output shaft) thereof.

A first end 118a of the power transmission member 118 is pivotally mounted to the eccentric shaft portion 116a. A second end 118b of the power transmission member 118 is mounted to the above-described upper connecting shaft 130 (see FIG. 16). The second end 118b is connected to a longitudinally intermediate part of the upper connecting shaft 130. The power transmission member 118 and the upper connecting shaft 130 are interconnected in a mutually pivotable manner.

The speed reducer 114 includes: a first speed reduction portion including a pulley 114a mounted to the output shaft of the motor 113, a pulley 114b mounted to the input shaft of the speed reducer 114 and a belt 114c entrained between these pulleys; and a second speed reduction portion including a worm gear and a worm wheel (not shown) accommodated in a case 14d (see FIG. 17). The worm wheel and the rotary member 116 are adapted for unitary rotation.

The motor 113 and the speed reducer 114 are mounted to the underpart member 111 of the seat frame 108. The motor 113 is capable of rotating based on a signal from the control unit 105. The motor 113 rotates to drive the rotary member 116 into rotation, thereby bringing the first end 118a of the power transmission member 118 into an eccentric rotation. Namely, the power transmission member 118 functions as a crank member for converting the rotary motion of the rotary member 116 into a transverse reciprocative motion of the seat body 107. As a result, the seat body 107 supported by the arm members 117 can be brought into a reciprocative swing motion in the transverse direction.

The speed reducer 114 includes the worm gear and the worm wheel accommodated in the second speed reduction portion and hence, has a self-locking mechanism which permits the rotary member 116 to be rotated by the rotation of the motor 113 thereby operating the power transmission member 118 but which inhibits the power transmission member 118 from rotating the rotary member 116 when the motor 113 is deactivated.

A specific sideways motion of the seat body 107 is described.

FIG. 17 shows the seat body 107 located at the center in the transverse direction or in the initial state (at the initial position). The seat body 107 is in this initial state when the use of the chair massager is started, when the use thereof is ended or when the arm members 117 are not operated to move the seat portion 101 sideways during the use of the chair massager. In this initial state, the left end portion 140 and the right end portion 141 of the seat surface 107a are at the same height.

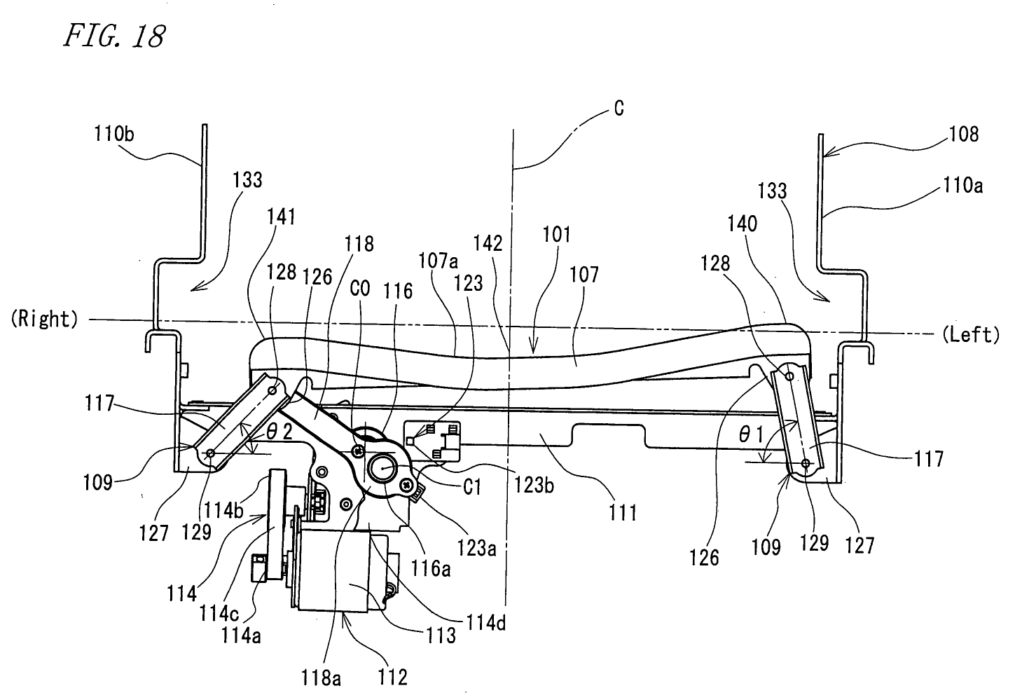

As seen in FIG. 17 and FIG. 18, when one (the right one) of the right and left arm members 117 is pivotally moved about the second shaft 129 to be inclined toward the other (left) arm member 117, namely the inclination angle of the right arm member 117 in the state shown in FIG. 17 is reduced (FIG. 18), the other (left) arm member 117 rises up from the state shown in FIG. 17 to increase the inclination angle from that of the initial position (θ0<θ1). Hence, the seat body 107 is moved to the other side (left side) in the transverse direction. In this state, the inclination angle θ1 of the left arm member 117 is greater than the inclination angle θ2 of the right arm member 117 (θ1>θ2), so that the left end portion 140 of the seat surface 107a is higher than the right end portion 141 thereof. It is noted that FIG. 17 shows a case where the seat portion 101 is not moved sideways or in a stationary state (the initial state) and a case where the seat portion 101 is in the course of the sideways motion.

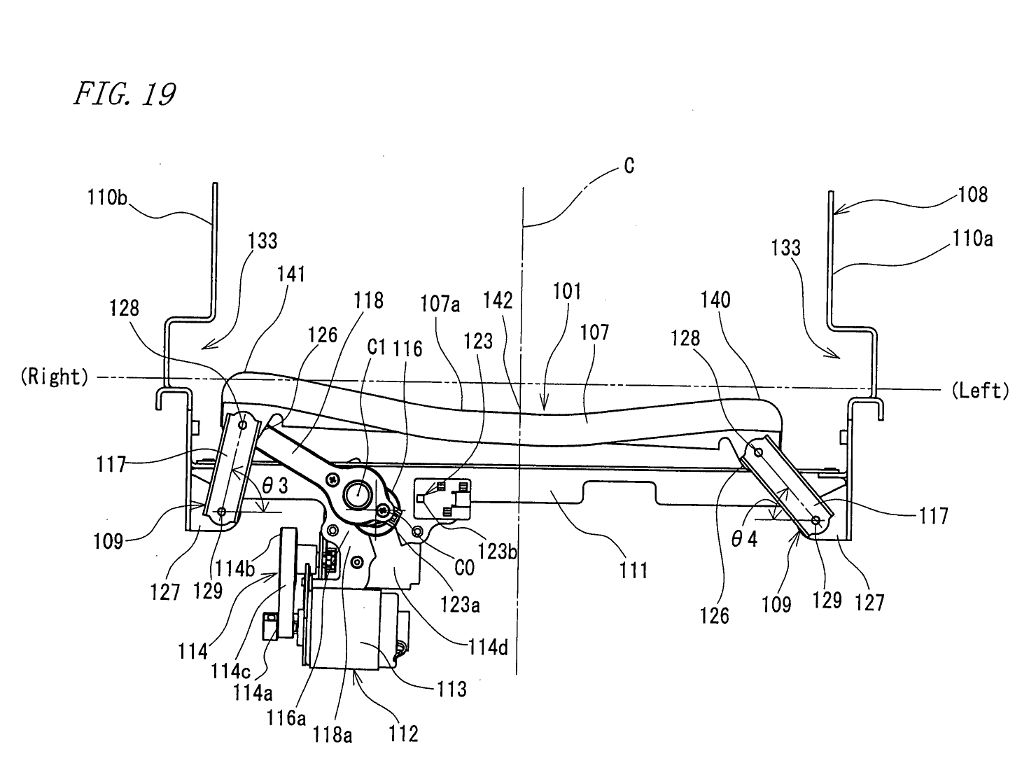

As seen in FIG. 19, when the other one (the left one) of the right and left arm members 117 is pivotally moved about the second shaft 129 to be inclined toward the one (right) arm member 117, namely the inclination angle of the left arm member 117 in the state shown in FIG. 17 is reduced (FIG. 19), the one (right) arm member 117 rises up from the state shown in FIG. 17 to increase the inclination angle from that of the initial position (θ0<θ3). Hence, the seat body 107 is moved to the one side (right side) in the transverse direction. In this state, the inclination angle θ4 of the left arm member 117 is smaller than the inclination angle θ3 of the right arm member 117 (θ4<θ3), so that the right end portion 141 of the seat surface 107a is higher than the left end portion 140 thereof.

In this manner, the inclination angle of the left arm member 117 and that of the right arm member 117 are made to differ from each other whereby the right and left arm members 117 move the seat body 107 sideways. Therefore, the seat body 107 moved to the right side assumes a position wherein the right end portion 141 of the seat surface 107a is higher than the left end portion 140 thereof. The seat body 107 moved to the left side assumes a position wherein the left end portion 140 of the seat surface 107a is higher than the right end portion 141 thereof. These arm members 117 are capable of moving the seat body 107 sideways as alternately inclining the seat surface 107a to the right and to the left, as shown in FIG. 18 and FIG. 19.

As described above, the seat surface 107a of the seat body 107 is in the form of the concave curve. In the state where the seat body 107 is moved to the leftmost position, as shown in FIG. 18, the right end portion 141 of the seat surface 107a is lowered but the right half of the seat surface 107a is upwardly inclined toward the right relative to the horizontal but not downwardly inclined toward the right. Similarly, in the state where the seat body 107 is moved to the rightmost position, as shown in FIG. 19, the left end portion 141 of the seat surface 107a is lowered but the left half of the seat surface 107a is upwardly inclined toward the left relative to the horizontal but not downwardly inclined toward the left. Therefore, when moved to the left side, the seat body 107 is prevented from throwing off the user seated on the seat surface 107a to the left side. When moved to the right side, the seat body 107 is prevented from throwing off the user to the right side. Hence, the user can feel relaxed.

The four arm members 117 support the seat body 107 as lifting up the seat body 107 from the seat frame 108. Therefore, when the user is seated on the seat body 107 at the initial position (the center position) shown in FIG. 17, the seat body 107 is subjected to a force to move the seat body either to the right or to the left. For instance, a force is exerted on the seat body 107 causing the right arm members 117 to fall down inwardly (toward the left) so that the seat body 107 is moved to the left.

In order to hold the seat body 107, to be moved either to the right or to the left, in the stationary state, the chair massager includes a mechanism (operative mechanism portion) which operates to prevent the change of the angles of rightward and leftward inclinations of the arm members 117 lifting and supporting the seat body 107 (prevent the arm members 117 from falling sideways). In order to establish an operable state wherein the seat body 107 is permitted to move sideways, this mechanism has a function to permit the change of the angles of rightward and leftward inclinations of the arm members 117 (to permit the arm members 117 to fall sideways) and to return the fallen arm members 117 to the initial position.

This mechanism comprises the above-described driving portion 112. Even though the arm members 117 are to change the angle of rightward or leftward inclination in the falling direction thereby pushing the power transmission member 118 toward the first end 118a thereof, the self-locking mechanism of the speed reducer 114 disables the rotation of the rotary member 116 when the motor 113 of the driving portion 112 is deactivated by the control unit 105. Thus, the stationary state of the seat body 107 is established using no power. At this time, the power transmission member 118 extending from the rotary member 116 restrained from rotating by the self-locking mechanism supports from below the arm members 117 tending to change the angle of rightward or leftward inclination in the falling direction.

On the other hand, when the motor 113 of the driving portion 112 is activated based on the signal from the control unit 105, the rotary member 116 can be brought into rotation. This enables the operation of the power transmission member 118 supporting from below the arm members 117 tending to change its angle of rightward or leftward inclination (tending to fall), so that the arm members 117 can be inclined to a predetermined inclination angle (θ2 in FIG. 18, θ4 in FIG. 19).

The motor 113 continues to rotate so that the power transmission member 118 pushes up the arm members 117 fallen to the predetermined inclination angle thereby returning the arm members 117 to the initial position (FIG. 17). Subsequently, the power transmission member 118 can move the arm members 117 again to the predetermined inclination angle as supporting the arm members 117 from below. This operation is repeated to bring the seat body 107 into the sideways motion.

Referring to FIG. 17, the chair massager includes a sensor 123 for detecting a transverse position of the seat body 107. The sensor 123 is disposed between the seat frame 108 and the driving portion 112. The sensor 123 is designed to detect the position of the seat body 107 by detecting the position of the power transmission member 118 relative to the seat frame 108.

More specifically, the first end 118a of the power transmission member 118 rotates one revolution while the rotary member 116 rotates one revolution around the axis C0, while the seat body 107 moves from the reference position shown in FIG. 17 to the leftward swing position in FIG. 18 and to the rightward swing position in FIG. 19 before moved back again to the reference position. Namely, the seat body 107 makes one cycle of sideways motion (one reciprocation) while the first end 118a of the power transmission member 118 rotates one revolution. The position of the transversely moving seat body 107 and the position of the eccentrically rotating first end 118a of the power transmission member 118 are in correspondence relation.

A detection target 123a is provided at the first end 118a of the power transmission member 118. A sensor body 123b is provided at the seat frame 108 (the underpart member 111). The sensor body 123b detects the detection target 123a and sends a detection signal to the control unit 105. The sensor body 123b detects the detection target 123a so that the control unit 105 can identify a particular eccentric rotational position of the first end 118a of the power transmission member 118 so as to determine a particular swing position of the seat body 107. While the sensor 123 (the sensor body 123b) may employ any position sensor known in the art, a non-contact type sensor such as a magnetic sensor (Hall IC) is preferred. What is needed in this case is to attach a magnet as the detection target 123a to the first end 118a of the power transmission member 118.

In a case where the above particular swing position of the seat body 107 is defined as the initial position, the sensor 123, the driving portion 112 and the control unit 105 may operate to bring the seat body 107 to a stop at the initial position. For this purpose, the sensor body 123b is adapted to detect the detection target 123a attached to the first end 118a of the power transmission member 118, when the seat body 107 is located at the initial position. When the sensor body 123b detects the detection target 123a, the control unit 105 issues a stop command (stop signal) to the driving portion 112 so as to deactivate the motor 113. In this manner, the control unit 105 issues the stop command to the driving portion 112 based on the detection signal from the sensor 123, thereby permitting the driving portion 112 to bring the seat body 107 to a stop at the initial position (the particular transverse position).

In order to stop the seat body 107 at the initial position, an alternative arrangement may also be made such that the sensor body 123b is capable of detecting the detection target 123a attached to the first end 118a of the power transmission member 118 just before the seat body 107 reaches the initial position. In this arrangement, when the sensor body 123b detects the detection target 123a, the control unit 105 issues the stop command to the driving portion 112, which in turn gradually reduces the rotational speed of the motor 113 before the seat body 107 reaches the initial position. Thus, the motor 113 comes to a complete stop when the seat body 107 reaches the initial position. In this manner, the seat body 107 is slowly brought to a stop at the initial position.

The control unit 105 can change the speed of eccentric rotation of the rotary member 116. The change of eccentric rotational speed can be accomplished by varying the number of revolutions of the motor 113, for example. Thus, the speed of the sideways motion of the seat body 107 can be changed so that the seat body 107 can be brought into a slow sideways motion or into a quick sideways motion.

The control unit 105 is capable of changing not only the speed of the sideways swing motion of the seat body 107 (swing speed) but also a swing duration time based on the user's control by means of the controller or in an autonomous manner. In a swing-only motion of the seat portion 101 (seat body 107), an automatic course program and a manual course program, which will be described hereinlater, the control unit 105 is programmed to continue the swing motion of the seat body 107 for a predetermined period of time (set time) as the swing time. The control unit 105 is adapted to change this swing time based on the user's control by means of the controller or in the autonomous manner.

According to the above-described arrangement, the seat body 107 is capable of sideways swing motion including a component in the height direction because the seat body 107 moves sideways as uplifting the left end portion 140 of the seat surface 107a thereof as shown in FIG. 18 or uplifting the right end portion 141 thereof as shown in FIG. 19. In the chair massager, the seat portion 101 (the seat body 107) performs the swing motion in this manner thereby offering a novel body sensation (swing feeling) to the user.

The moment the seat portion 101 having the user seated thereon and moving to the right changes the direction of movement toward the left, a rightward inertial force is exerted on the user having been moved rightward. According to the chair massager of the invention, however, a force to incline leftward the user seated on the seat surface 107a is produced when the seat portion 101 is moved rightward because the seat surface 107a is downwardly inclined toward the left or the right end portion 141 of the seat surface 107a is higher than the left end portion 140 thereof. In consequence, the inertial force exerted on the user is reduced, so that the user need not tense up his/her body to resist the inertial force. Therefore, the swing motion performed by the seat portion 101 of the chair massager can make the user relaxed.

The above-described operation does not swing too wide the upper body (the head region) of the user in the transverse direction and besides, permits the user to lean on the backrest portion 102. The operation can swing the upper body of the user transversely about the head of the user so that the user can feel relaxed.

The seat portion 101 (seat body 107) is transversely moved between the right and left armrest portions 103a, 103b. Hence, the seat portion 101 is moved sideways with the user having his/her arms placed on the armrest portions 103a, 103b. By virtue of the armrest portions 103a, 103b on the lateral sides, the chair massager can make the user feel safe and relaxed when the seat portion 101 is moved sideways.

The chair massager has the structure wherein the arm members 117 do not abut on the lateral sides of the seat body 107 because the arm members 117 support the seat body 107 as uplifting the seat body from below. This permits the seat body 107 (seat surface 107a) disposed between the side wall portions 110a, 110b to be increased in the transverse dimension.

The seat body 107 is provided with the pad (not shown) thereon, as described above. As shown in FIG. 17, therefore, recesses adapted to receive lateral side edges of the pad are formed on lateral inner sides of the seat frame 108 such that the pad may not interfere with the sideways motion of the seat body 107 by hitting against the side wall portions 110a, 110b in conjunction with the sideways motion of the seat body 107. Specifically, the side wall portions 110a, 110b are formed with grooves 133 extending in the fore-aft direction to serve as the recesses. The grooves 133 receive the lateral side edges of the pad thereby permitting the seat body 107 to move sideways at a predetermined stroke without interfering with the seat frame 108.

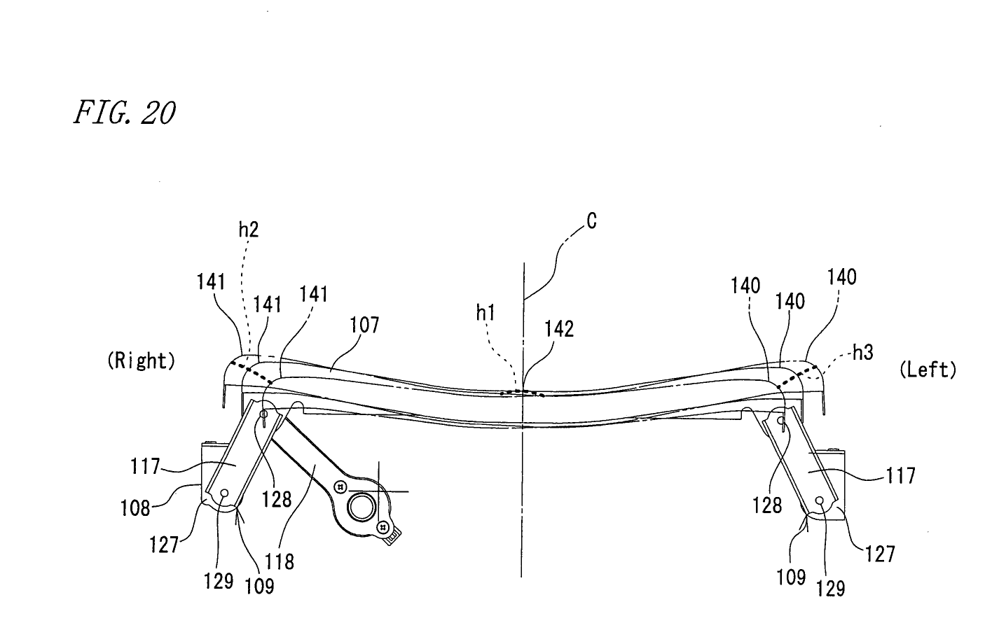

FIG. 20 is a diagram for illustrating a movement locus of the seat body 107. This figure depicts the seat body 107, the arm members 117, the frame connecting portions 127 of the seat frame 108 and the power transmission member 118. The solid line represents the seat body 107 at the initial position (center position), the dot-dash line representing the seat body 107 moved to the rightmost position, the chain double-dashed line representing the seat body 107 moved to the leftmost position. The broken lines h1, h2, h3 represent the respective movement loci of the central portion 142, right end portion 141 and left end portion 140 of the seat surface 107a of the seat body 107.

As indicated by the broken lines h1, h2, h3, the seat surface 107a (the central portion 142, the right end portion 141 and the left end portion 140 thereof) traces a locus along an upwardly convexed arc. Thus, the seat body can carry the user seated thereon rightward or leftward as lifting up the user. Accordingly, the seat portion 101 makes a comfortable swing motion.

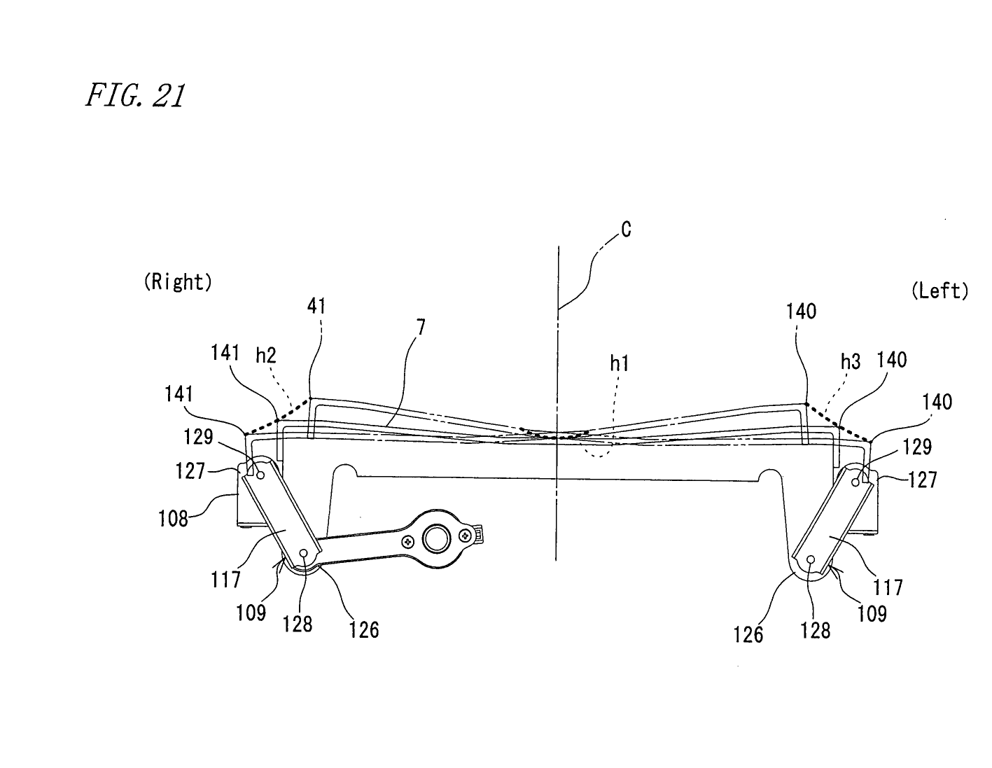

FIG. 21 is a diagram illustrating a chair massager according to another embodiment of the invention. The figure shows a seat structure of this chair massager. The chair massager has the structure wherein the seat body 107 suspends from the frame connecting portions 127 of the seat frame 108 by means of the four arm members 117 disposed at the forward-left, rearward-left, forward-right and rearward-right places.

The right and left arm members 117 are angularly disposed so as to be progressively decreased in space therebetween toward bottom. Even in the structure wherein the seat body 107 is suspended, the seat connecting portion 126 has a greater dimension than the arm member 117 with respect to the height direction whereby the seat surface 107a is located at a higher level than the second shafts 129 serving as the pivot points of the seat frame 108.

This embodiment is principally arranged the same way as the above embodiments except for the structure of mounting the seat body 107 by means of the arm members 117.

Specifically, the right and left arm members 117 support the seat body 107 as suspending the lateral sides of the seat body 107 from the lateral side portions of the seat frame 108. The right and left arm members 117 are varied in the angles of rightward and leftward inclinations thereby providing for the sideways motion of the seat body 107. The right and left arm members 117, 117 transversely movably mount the seat portion 101 to the seat frame 108 in a manner that the right and left arm members are inclined at different angles thereby raising the right end portion 141 of the seat surface 107a higher than the left end portion 140 when the seat portion 101 is on the right side, or raising the left end portion 140 of the seat surface 107a higher than the right end portion 141 thereof when the seat portion 101 is on the left side.

In this embodiment, the seat surface 107a traces a locus along a downwardly convexed arc in conjunction with the sideways motion of the seat body 107, as illustrated by the broken lines h1, h2, h3 in FIG. 21.

Now, description is made on massaging operation by the chair massagers of the above embodiments.

The control unit 105 is capable of driving the seat portion 101 alone into the sideways motion while deactivating the other operating portions. The user may manually operate the controller for selecting the swing-only motion of the seat portion 101 (seat body 107). In this case, the seat portion 101 alone performs the swing motion.

Further, the control unit is also capable of driving the seat portion 101 into the sideways motion in combination with the operation of any other operating portion. This operation mode is also selected by the user manipulating the controller.

Otherwise, the control unit 105 may follow the massage programs (computer programs) stored therein for driving the seat portion 101 alone into the sideways motion or driving the seat portion into the sideways motion in combination with any other operating portion. The massage program may also be selected by the user manipulating the controller.

Description is made on the combined operations. The control unit 105 stores the automatic course program for the swing motion of a seat portion 101. This automatic course program is selected by the user by means of the controller. When this automatic course program is selected, the control unit 105 drives the seat portion 101 into the sideways motion and also automatically activates any other massaging device. The other massaging device is exemplified by the massaging devices 121 disposed on the seat portion 101 on the lateral sides thereof (see FIG. 13). The massaging devices 121 are air cells. The air cells are inflated and deflated for clampingly massaging the user on his/her lateral sides while the seat portion 101 is moved sideways. The other massaging device may also be exemplified by the massaging device 120b of the leg-rest portion 120 (see FIG. 13), or the massage unit 104 (massaging element 104a) disposed at the backrest portion 102.

The control unit 105 further stores the manual course program for the swing motion of the seat portion 101. When this manual course program is selected, the control unit 105 drives the seat portion 101 into the sideways motion. In addition, the control unit permits the user to activate any other massaging device at the user's option by manipulating the controller. Thus, the optional massaging operation by any other massaging device may be selectively performed in synchronism with the swing motion of the seat portion 101 according to the user's preference.

Further, the control unit 105 is capable of varying the swing speed and the swing time during conducting the automatic course program, the manual course program or the swing-only motion, as described above. Even when the swing motion alone is performed, therefore, the control unit keeps the user from being bored, thus providing the relaxation effect to the user. The relaxation effect is further enhanced because of the variable swing speed and swing time.

As represented by the chain double-dashed lines in FIG. 15, each of the side wall portions 110a, 110b of the seat frame 108 is provided with front, central and rear air cells 121a, 121b, 121c in the fore-aft direction thereof, which serve as the massaging devices 121 on the seat portion 101. The front air cell 121a is inflated in a manner to press on the user horizontally and rearwardly. The rear air cell 121c is inflated in a manner to press on the user horizontally and forwardly. The central air cell 121b is inflated in a manner to press down on the user from above toward the seat surface 107a.

The massaging devices 121 on the seat portion 101 have a function to hold the user seated on the swinging seat portion 101 by clamping the user on the lateral sides or to prevent the user from being displaced from the seat portion 101 as well as a function to provide the massaging effect.

As shown in FIG. 13, the seat portion 101 includes air cells 137 adapted to press upward on the user seated thereon. The air cells 137 are disposed at front and rear portions of the seat portion 101, respectively. The control unit 105 may inflate/deflate these air cells 137 while the seat portion 101 is moved sideways. These air cells 137 are mounted on the seat body 107 so as to be brought into the sideways motion together with the seat body 107.

The chair massager of the invention is not limited to the illustrated embodiments and may be practiced in any other mode within the scope of the invention. For instance, the chair massager may be free from the leg-rest portion 120 mounted to the base portion 106. An additional massaging device capable of performing the massaging operation on the body of the user may also be provided at the seat portion 101, the backrest portion 102, the leg-rest portion 120 or the armrest portions 103a, 103b.

According to the chair massager constituted as described above, the chair massager including the seat portion and the backrest portion can offer a novel body sensation to the user by driving the seat portion into the sideways swing motion wherein the left end portion and right end portion of the seat surface are alternately lifted up.

What is claimed is:

1. A chair comprising a seat portion for a user to be seated thereon, wherein the seat portion makes a swing motion including a component in a height direction.

2. A chair according to claim 1, further comprising:
a seat body an upper side of which defines a seat surface for the user to be seated thereon and which belongs to the seat portion, and
a frame supporting the seat body in a manner to permit the seat body to move between a center position and swing positions to which the seat body is swung from the center position,
wherein the height of the seat surface determined when the seat body is at the center position is lower than the height of the seat surface determined when the seat body is at the swing position.

3. A chair according to claim 2, further comprising a driving portion for forcibly moving the seat body.

4. A chair according to claim 2, further comprising:
a sensor for detecting a position of the seat body; and
a returning operation portion operating based on the position of the seat body detected by the sensor for returning the seat body to the center position as a reference position.

5. A chair according to claim 2, wherein the frame includes support members for suspendingly supporting the seat body.

6. A chair according to claim 2, wherein as located at the swing position, the seat surface assumes a horizontal position or a position downwardly inclined toward the center position.

7. A chair according to claim 1, further comprising:
a base portion to be placed on a floor;
a backrest portion provided at the base portion for supporting the upper body of the user;
the seat portion having a seat surface defined by an upper side thereof;
a mounting portion transversely movably mounting the seat portion to the base portion in a manner that the seat portion is moved rightward as raising a right end portion of the seat surface higher than a left end portion thereof and that the seat portion is moved leftward as raising the left end portion of the seat surface higher than the right end portion thereof; and
a driving portion for driving the seat portion into sideways motion.

8. A chair according to claim 7, further comprising armrest portions disposed on lateral sides of the base portion for supporting the arms of the user,
wherein the seat portion is transversely moved between the right and left armrest portions.

9. A chair according to claim 7, wherein the mounting portion includes arm members which support the seat portion as lifting the lateral sides thereof upward from the lateral sides of the base portion and which are varied in the angles of rightward and leftward inclinations thereby providing for the sideways motion of the seat body.

10. A chair according to claim 9, further comprising an operative mechanism portion for switching the state of the seat portion between a stationary state wherein the seat portion is held stationary by preventing the variation of the angles of the rightward and leftward inclinations of the arm members liftingly supporting the seat portion and an operable state wherein the arm members can be varied in the angles of rightward and leftward inclinations thereby providing for the sideways motion of the seat portion.

11. A chair according to claim 7, wherein the mounting portion includes right and left arm members which extend from the lateral sides of the base portion for supporting lateral sides of the seat portion and which are varied in the angles of rightward and leftward inclinations from those in the supporting state thereby providing for the sideways motion of the seat body, and
wherein the right and left arm members transversely movably mount the seat portion to the base portion in a manner that the right and left arm members are inclined at different angles thereby moving the seat portion rightward as uplifting the right end portion of the seat surface higher than the left end portion thereof or thereby moving the seat portion leftward as uplifting the left end portion of the seat surface higher than the right end portion thereof.

12. A chair according to claim 7, further comprising a sensor for detecting a rightward or leftward position of the seat portion;
and a control unit for providing a control to bring the seat portion to a stop at a predetermined rightward or leftward position based on a detection signal from the sensor.
